(19) United States
(12) Patent Application Publication
(10) Pub. No.: US 2025/0047329 A1
(43) Pub. Date: Feb. 6, 2025

(54) MIMO OPERATIONS

(71) Applicant: Samsung Electronics Co., Ltd., Suwon-si (KR)

(72) Inventors: Md. Saifur Rahman, Plano, TX (US); Eko Onggosanusi, Coppell, TX (US); Gilwon Lee, McKinney, TX (US); Emad Nader Farag, Flanders, NJ (US); Dalin Zhu, Allen, TX (US)

(21) Appl. No.: 18/774,822

(22) Filed: Jul. 16, 2024

Related U.S. Application Data
(60) Provisional application No. 63/528,284, filed on Jul. 21, 2023.
(60) Provisional application No. 63/529,530, filed on Jul. 28, 2023.
(60) Provisional application No. 63/563,799, filed on Mar. 11, 2024.
(60) Provisional application No. 63/564,365, filed on Mar. 12, 2024.

(51) Int. Cl. H04B 7/0413; H04B 7/06

(52) U.S. Cl. CPC H04B 7/0413; H04B 7/06968

(57) ABSTRACT

Apparatuses and methods for dynamic MIMO operations. A method performed by a user equipment (UE) includes receiving information about N ports and a report; based on the information, determining γ port selection hypotheses, where a port selection hypothesis with index l selects a group of n₁ ports from the N ports; and transmitting the report including at least one indicator indicating the γ port selection hypotheses, where γ≥1, l ∈{1, . . . , γ}, and 1≤nₗ≤N.

### CROSS-REFERENCE TO RELATED APPLICATION AND CLAIM OF PRIORITY

This application claims priority under 35 U.S.C. § 119(e) to U.S. Provisional Patent Application No. 63/528,284 filed on Jul. 21, 2023; U.S. Provisional Patent Application No. 63/529,530 filed on Jul. 28, 2023; U.S. Provisional Patent Application No. 63/563,799 filed on Mar. 11, 2023; and U.S. Provisional Patent Application No. 63/564,365 filed on Mar. 12, 2024. The contents of these provisional patent applications are hereby incorporated by reference in their entirety.

### TECHNICAL FIELD

The present disclosure relates generally to wireless communication systems and, more specifically, to dynamic multiple input multiple output (MIMO) operations.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for dynamic MIMO operations.

In one embodiment, a user equipment (UE) is provided. The UE includes a transceiver configured to receive information about N ports and a report and a processor operably coupled to the transceiver. The processor, based on the information, is configured to determine Y port selection hypotheses, where a port selection hypothesis with index l selects a group of nₗ ports from the N ports. The transceiver is further configured to transmit the report including at least one indicator indicating the γ port selection hypotheses, where γ≥1, l ∈{1, . . . , γ}, and 1≤nₗ≤N.

In another embodiment, a base station (BS) is provided. The BS includes a processor and a transceiver operably coupled to the processor. The transceiver is configured to transmit information about N ports and a report and receive the report including at least one indicator indicating γ port selection hypotheses, where a port selection hypothesis with index l selects a group of nₗ ports from the N ports and where γ≥1, l ∈{1, . . . , γ}, and 1≤nₗ≤N.

In yet another embodiment, a method performed by a UE is provided. The method includes receiving information about N ports and a report; based on the information, determining Y port selection hypotheses, where a port selection hypothesis with index l selects a group of nₗ ports from the N ports; and transmitting the report including at least one indicator indicating the Y port selection hypotheses, where γ≥1, l ∈{1, . . . , γ}, and 1≤nₗ≤N.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4 and 5 illustrate example wireless transmit and receive paths according to embodiments of the present disclosure;

FIG. 6 illustrates a transmitter block diagram for a physical downlink shared channel (PDSCH) in a subframe according to embodiments of the present disclosure;

FIG. 7 illustrates a receiver block diagram for a PDSCH in a subframe according to embodiments of the present disclosure;

FIG. 8 illustrates a transmitter block diagram for a physical uplink shared channel (PUSCH) in a subframe according to embodiments of the present disclosure;

FIG. 9 illustrates a receiver block diagram for a PUSCH in a subframe according to embodiments of the present disclosure;

FIG. 10 illustrates an example antenna blocks or arrays forming beams according to embodiments of the present disclosure;

FIGS. 11A and 11B illustrate example antenna port layout and antenna group TRPs according to embodiments of the present disclosure;

FIG. 12 illustrates co-located and distributed antenna or port groups (AGs)/(PGs) serving a moving UE according to embodiments of the present disclosure;

FIG. 13 illustrates an example of RBs in a channel according to embodiments of the present disclosure;

FIG. 14 illustrates an example of port or beam selection according to embodiments of the present disclosure;

FIG. 15 illustrates examples of AG selection hypotheses according to embodiments of the present disclosure;

FIG. 16 illustrates an example of an analog beam-based NW topology 1600 according to embodiments of the present disclosure; and

FIG. 17 illustrates an example method performed by a UE in a wireless communication system according to embodiments of the present disclosure.

### DETAILED DESCRIPTION

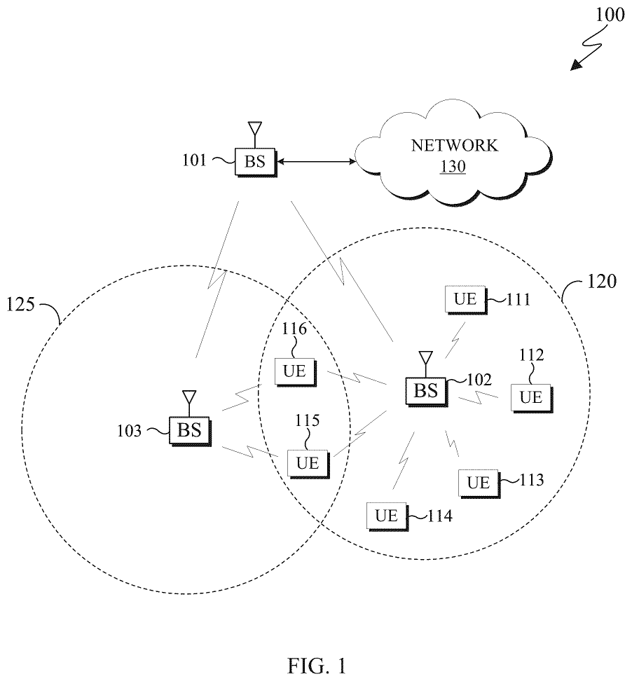

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.3.0, “E-UTRA, Physical channels and modulation (herein “REF 1”);” 3GPP TS 36.212 v17.1.0, “E-UTRA, Multiplexing and Channel coding” (herein “REF 2”); 3GPP TS 36.213 v17.3.0, “E-UTRA, Physical Layer Procedures” (herein “REF 3”); 3GPP TS 36.321 v17.3.0, “E-UTRA, Medium Access Control (MAC) protocol specification” (herein “REF 4”); 3GPP TS 36.331 v17.3.0, “E-UTRA, Radio Resource Control (RRC) Protocol Specification” (herein “REF 5”); 3GPP TR 22.891 v1.2.0 (herein “REF 6”); 3GPP TS 38.212 v17.3.0, “E-UTRA, NR, Multiplexing and Channel coding” (herein “REF 7”); 3GPP TS 38.214 v17.3.0, “E-UTRA, NR, Physical layer procedures for data” (herein “REF 8”); and 3GPP TS 38.211 v17.3.0, “E-UTRA, NR, Physical channels and modulation” (herein “REF 9”).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying or utilizing dynamic MIMO operations. In certain embodiments, one or more of the BSs 101-103 include circuitry, programing, or a combination thereof to provide or support dynamic MIMO operations.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

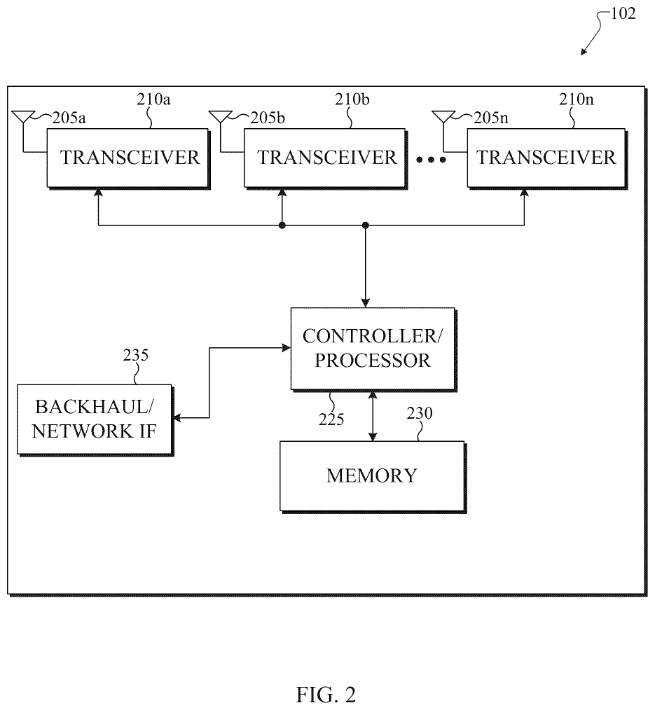

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting compression-based CSI reporting. Any of a wide variety of other functions could be supported in the gNB 102 by the controller/processor 225.

The controller/processor 225 is also capable of executing programs and other processes resident in the memory 230, such as processes for supporting dynamic MIMO operations. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

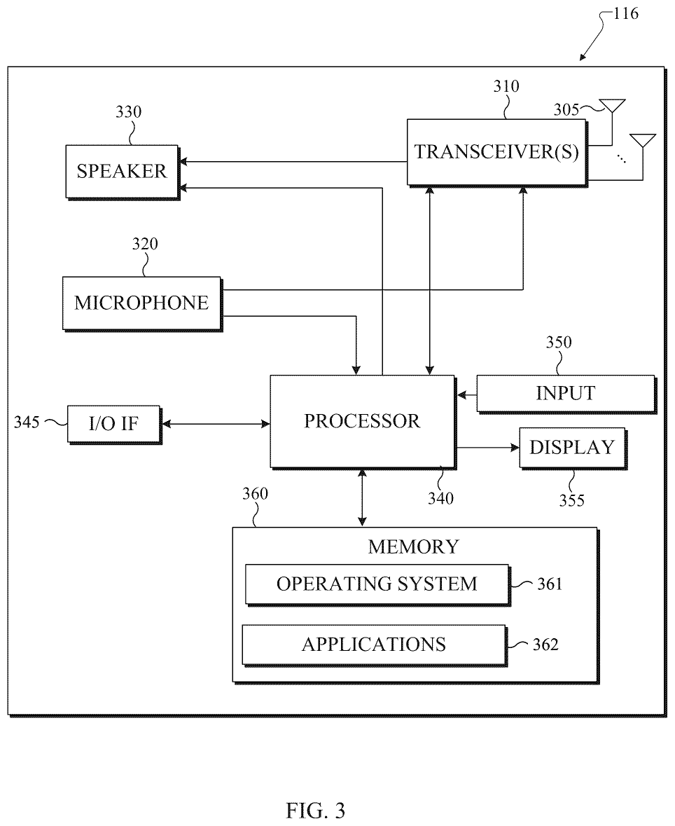

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for identifying and utilizing dynamic MIMO operations. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

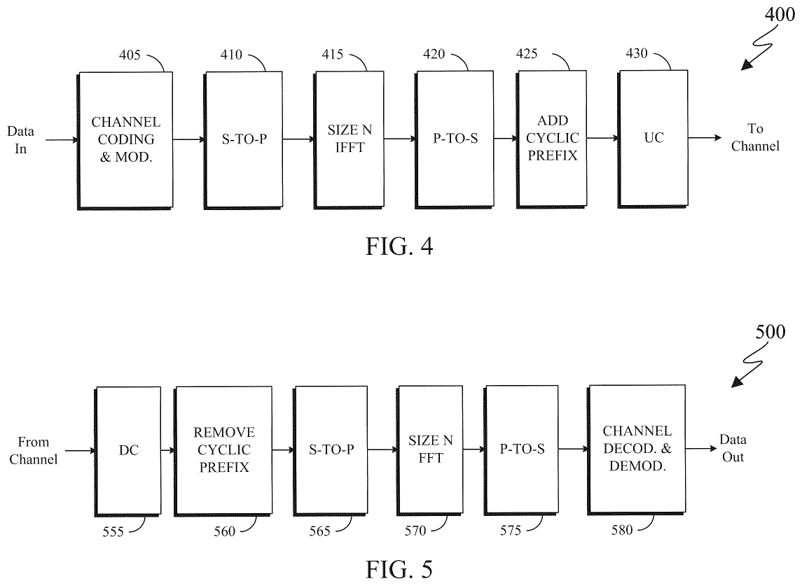

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support use of dynamic MIMO operations as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH)—see also REF 3. An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or resource elements (REs), such as 12 REs. A unit of one RB over one subframe is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

A UL subframe (or slot) includes two slots. Each slot includes N_{symb}^{UL} symbols for transmitting data information, UCI, DMRS, or SRS. A frequency resource unit of an UL system BW is an RB. A UE is allocated N_{sc}^{RB} RBs for a total of N_{sc}^{RB}·N_{sc}^{RB} REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is N_{symb}=2·(N_{symb}^{UL}−1)−N_{SRS}, where N_{SRS}=1 if a last subframe (or slot) symbol is used to transmit SRS and N_{SRS}=0 otherwise.

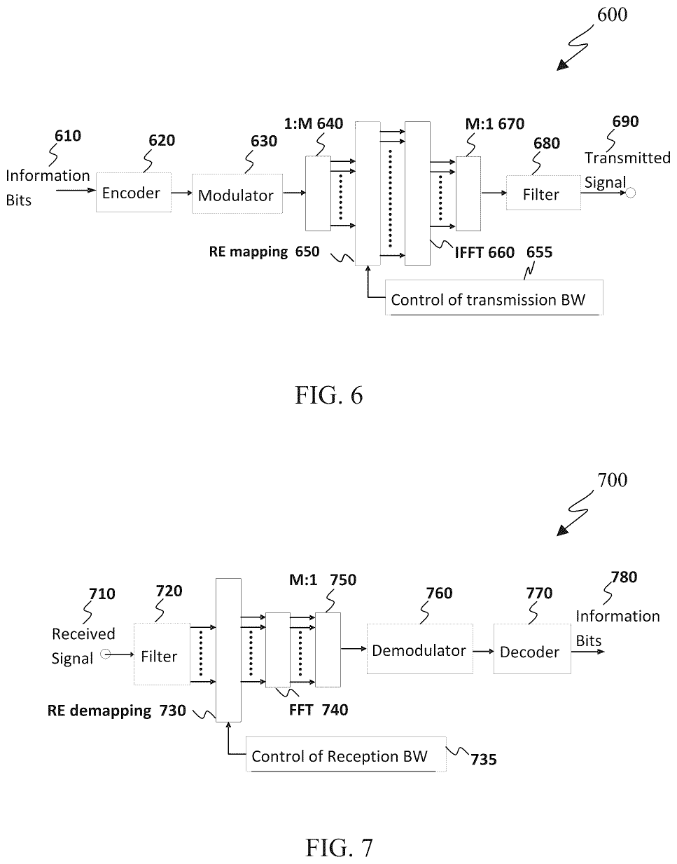

FIG. 6 illustrates a transmitter block diagram 600 for a PDSCH in a subframe according to embodiments of the present disclosure. The embodiment of the transmitter block diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the transmitter block diagram 600.

As shown in FIG. 6, information bits 610 are encoded by encoder 620, such as a turbo encoder, and modulated by modulator 630, for example using quadrature phase shift keying (QPSK) modulation. A serial to parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse fast Fourier transform (IFFT), the output is then serialized by a parallel to serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates a receiver block diagram 700 for a PDSCH in a subframe according to embodiments of the present disclosure. The embodiment of the diagram 700 illustrated in FIG. 7 is for illustration only. One or more of the components illustrated in FIG. 7 can be implemented in specialized circuitry configured to perform the noted functions or one or more of the components can be implemented by one or more processors executing instructions to perform the noted functions. FIG. 7 does not limit the scope of this disclosure to any particular implementation of the diagram 700.

As shown in FIG. 7, a received signal 710 is filtered by filter 720, REs 730 for an assigned reception BW are selected by BW selector 735, unit 740 applies a fast Fourier transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

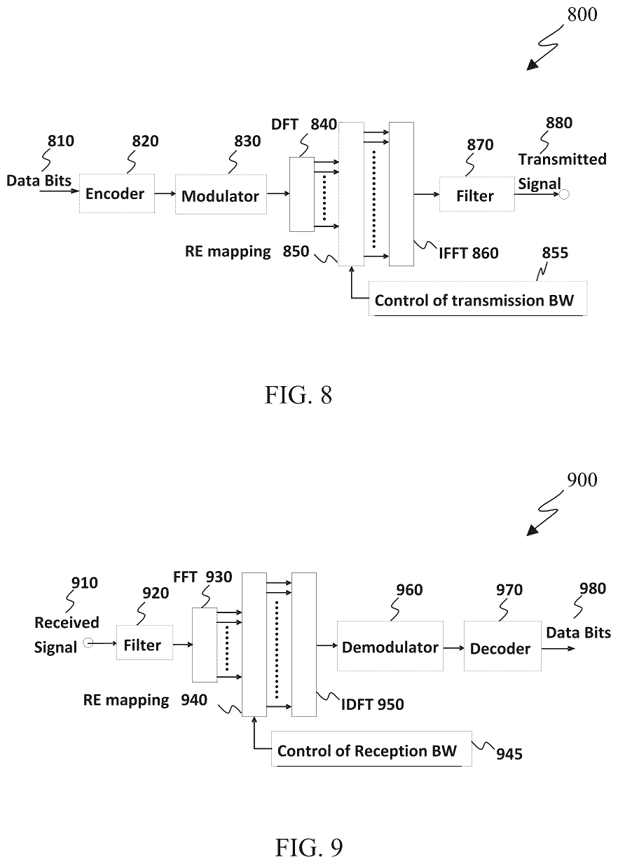

FIG. 8 illustrates a transmitter block diagram 800 for a PUSCH in a subframe according to embodiments of the present disclosure. One or more of the components illustrated in FIG. 7 can be implemented in specialized circuitry configured to perform the noted functions or one or more of the components can be implemented by one or more processors executing instructions to perform the noted functions. The embodiment of the block diagram 800 illustrated in FIG. 8 is for illustration only. FIG. 8 does not limit the scope of this disclosure to any particular implementation of the block diagram 800.

As shown in FIG. 8, information data bits 810 are encoded by encoder 820, such as a turbo encoder, and modulated by modulator 830. A discrete Fourier transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

FIG. 9 illustrates a receiver block diagram 900 for a PUSCH in a subframe according to embodiments of the present disclosure. The embodiment of the block diagram 900 illustrated in FIG. 9 is for illustration only. One or more of the components illustrated in FIG. 9 can be implemented in specialized circuitry configured to perform the noted functions or one or more of the components can be implemented by one or more processors executing instructions to perform the noted functions. FIG. 9 does not limit the scope of this disclosure to any particular implementation of the block diagram 900.

As shown in FIG. 9, a received signal 910 is filtered by filter 920. Subsequently, after a cyclic prefix is removed (not shown), unit 930 applies an FFT, REs 940 corresponding to an assigned PUSCH reception BW are selected by a reception BW selector 945, unit 950 applies an inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown below.

| Frequency range designation | Corresponding frequency range |
|---|---|
| FR1 | 450 MHZ - 6000 MHz |
| FR2 | 24250 MHz - 52600 MHZ |

For MIMO in FR1, up to 32 CSI-RS antenna ports is supported, and in FR2, up to 8 CSI-RS antenna ports is supported. In next generation cellular standards (e.g., 6G), in addition to FR1 and FR2, new carrier frequency bands can be considered, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across all antenna ports is possible.

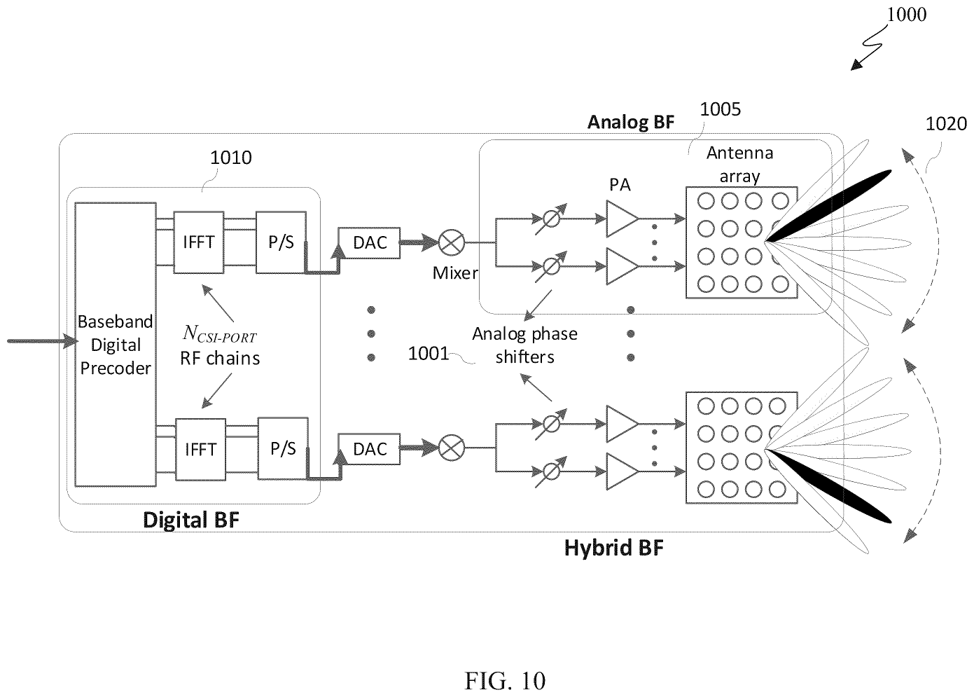

FIG. 10 illustrates an example antenna blocks or arrays 1000 according to embodiments of the present disclosure. The embodiment of the antenna blocks or arrays 1000 illustrated in FIG. 10 is for illustration only. FIG. 10 does not limit the scope of this disclosure to any particular implementation of the antenna blocks or arrays.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 10. In this case, one CSI-RS port is mapped onto a large number of antenna elements which can be controlled by a bank of analog phase shifters 1001. One CSI-RS port can then correspond to one sub-array which produces a narrow analog beam through analog beamforming 1005. This analog beam can be configured to sweep across a wider range of angles 1020 by varying the phase shifter bank across symbols or subframes (or slots). The number of sub-arrays (equal to the number of RF chains) is the same as the number of antenna ports N_{PORT}. A digital beamforming unit 1010 performs a linear combination across N_{PORT} analog beams to further increase precoding gain. While analog beams are wideband (hence not frequency-selective), digital precoding can be varied across frequency sub-bands or resource blocks. Receiver operation can be conceived analogously.

Embodiments of the present disclosure recognize that in a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For TDD systems, the CSI can be acquired using the SRS transmission relying on the channel reciprocity. For FDD systems, on the other hand, it can be acquired using the CSI-RS transmission from eNB (or gNB), and CSI acquisition and feedback from UE. In other FDD systems, the CSI feedback framework is ‘implicit’ in the form of CQI/PMI/RI (also CRI and LI) derived from a codebook assuming SU transmission from eNB (or gNB).

In 5G or NR systems [REF7, REF8], the above-mentioned “implicit” CSI reporting paradigm from LTE is also supported and referred to as Type I CSI reporting. In addition, a high-resolution CSI reporting, referred to as Type II CSI reporting, is also supported in Release 15 specification to provide more accurate CSI information to gNB for use cases such as high-order MU-MIMO. However, the overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of P_{CSI-RS}/2 CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

In Rel. 17 NR, CSI reporting has been enhanced to support the following.
Further enhanced Type II port selection codebook: it has been known in the literature that UL-DL channel reciprocity can exist in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and DFT-based FD basis in W_{f} can be replaced with SD and FD port selection, i.e., L CSI-RS ports are selected in SD and/or M ports are selected in FD. The CSI-RS ports in this case are beamformed in SD (assuming UL-DL channel reciprocity in angular domain) and/or FD (assuming UL-DL channel reciprocity in delay/frequency domain), and the corresponding SD and/or FD beamforming information can be obtained at the gNB based on UL channel estimated using SRS measurements. In Rel. 17, such a codebook is supported (which is referred to as Rel. 17 further enhanced Type II port selection codebook in REF8).
NCJT CSI reporting: When the UE can communicate with multiple TRPs that are distributed at different locations in space (e.g., within a cell), the CSI reporting can correspond to a single TRP hypothesis (i.e., CSI reporting for one of the multiple TRPs), or multi-TRP hypothesis (i.e., CSI reporting for at least two of the multiple TRPs). The CSI reporting for both single TRP and multi-TRP hypotheses are supported in Rel. 17. However, the multi-TRP CSI reporting considers a non-coherent joint transmission (NCJT), i.e., a layer (and precoder) of the transmission is restricted to be transmitted from only one TRP.

In Rel. 18 NR MIMO, the following CSI enhancements are further considered targeting two use cases (coherent joint transmission from multiple TRPs, and high/medium velocity UEs):
Enhancements of CSI acquisition for Coherent-JT targeting FR1 and up to 4 TRPs, assuming ideal backhaul and synchronization as well as the same number of antenna ports across TRPs, as follows:
   Rel-16/17 Type-II codebook refinement for CJT mTRP targeting FDD and its associated CSI reporting, taking into account throughput-overhead trade-off.
CSI reporting enhancement for high/medium UE velocities by exploiting time-domain correlation/Doppler-domain information to assist DL precoding, targeting FR1, as follows:
   Rel-16/17 Type-II codebook refinement, without modification to the spatial and frequency domain basis.
   UE reporting of time-domain channel properties measured via CSI-RS for tracking.

In next generation MIMO systems, the number of antenna ports is expected to increase further (e.g., up to 256), for example, for carrier frequencies in upper mid-band (10-15 GHz); the NW deployments are likely to be denser/more distributed (when compared with 5G NR); and the system is expected to work seamlessly even in challenging scenarios such as medium-high (e.g., 120 kmph) speed UEs, ‘higher-order) multi-user MIMO; and more dynamic MIMO operations will necessary for use cases requiring network energy saving, duplexing operations, re-configurability of the antenna surfaces (aka RIS) and prediction. The MIMO operations in such a system should be based on small number (preferably 1) of basic entities such as antenna or port group, whose characteristics (power, coverage, directionality etc.) can be changed dynamically (on the fly). This disclosure proposes one such framework and components tailored towards operating such MIMO systems.

The present disclosure relates to next generation MIMO systems (e.g., adv. 5G and 6G). In particular, it relates to a dynamic MIMO operations based on a single basis entity spatial domain, namely a “port”, which can be controlled by a digital chain. Port can be an abstraction for a spatial resource/unit:
In FR1, the spatial resource/unit can map to an antenna or multiple antennae via a fixed/static beam/virtualization.
In FR2, the spatial resource/unit is associated with an (analog) beam or a panel (capable for forming at least one beam), or source RS with a quasi-co-location (QCL) Type (e.g., Type A or/an D), or QCL-info with at least one source RS, or transmission configuration indicator (TCI) state with at least one QCL-info or at least one source RS.

A group of ports or antenna/port group (AG or PG) can be an abstraction for multiple spatial resources/units associated with CSI for multiple ports or multi-beam (e.g., JPTA, CP-MIMO), multi-panel, a TRP, multiple TRPs, a channel measurement resource etc.

PG can be useful for a wide range of applications such as traditional MIMO (FR1), beam-formed MIMO (FR2 and beyond), dynamic port assignment for network energy saving and duplexing operations, predictive MIMO (mobility scenarios) etc.:
Coherency (full, partial, non-coherent) and multiple MIMO hypotheses
Two-dimensional (ports/PGs vs layers, ports/PGs vs port selection hypotheses)
CSI reporting (e.g., RI/CQI/PMI)

Aspects, features, and advantages of the present disclosure are readily apparent from the following detailed description, simply by illustrating a number of particular embodiments and implementations, including the best mode contemplated for carrying out the present disclosure. The present disclosure is also capable of other and different embodiments, and its several details can be modified in various obvious respects, all without departing from the spirit and scope of the present disclosure. Accordingly, the drawings and description are to be regarded as illustrative in nature, and not as restrictive. The present disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

The present disclosure covers several components which can be used in conjunction or in combination with one another, or can operate as standalone schemes.

Depending on the network type, the term “base station” or “BS” can refer to any component (or collection of components) configured to provide wireless access to a network, such as transmit point (TP), transmit-receive point (TRP), an enhanced base station (eNodeB or eNB), gNB, a macrocell, a femtocell, a WiFi access point (AP), or other wirelessly enabled devices. Base stations may provide wireless access in accordance with one or more wireless communication protocols, e.g., 5G 3GPP New Radio Interface/Access (NR), long term evolution (LTE), LTE advanced (LTE-A), High Speed Packet Access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

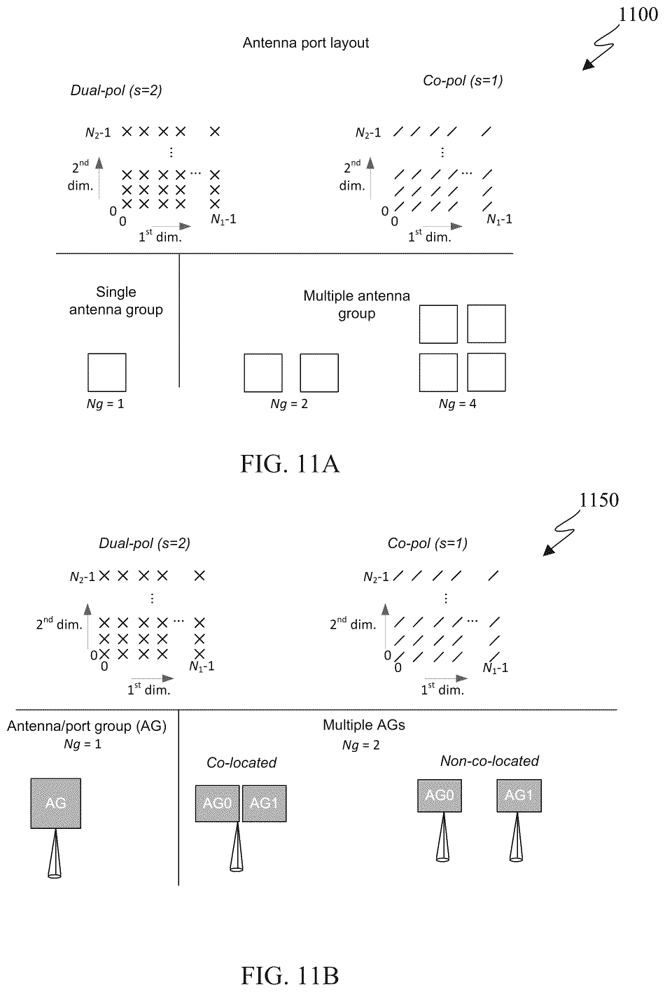

FIGS. 11A and 11B illustrate example antenna port layout and antenna group TRPs 1100 and 1150 according to embodiments of the present disclosure. The embodiment of the antenna port layout and antenna group TRPs 1100 and 1150 illustrated in FIGS. 11A and 11B is for illustration only. FIGS. 11A and 11B does not limit the scope of this disclosure to any particular implementation of antenna port layout and antenna group TRPs.

As illustrated in FIGS. 11A and 11B, N₁ and N₂ are the number of antenna ports with the same polarization in the first and second dimensions, respectively. For 2D antenna port layouts, there are N₁>1, N₂>1, and for 1D antenna port layouts N₁>1 and N₂=1 (or N₁=1 and N₂>1). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIGS. 11A and 11B where “X” represents two antenna polarizations. In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Dual-polarized antenna payouts are assumed in this disclosure. The embodiments (and examples) in this disclosure however are general and are applicable to single-polarized antenna layouts as well.

Let s denote the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=s₁N₂.

Let N_{g} be a number of antenna/port groups (AGs). When there are multiple antenna groups (N_{g}>1), each group (g ∈{1, . . . , N_{g}}) comprises dual-polarized antenna ports with N_{1,g} and N_{2,g} ports in two dimensions. This is illustrated in FIGS. 11A and 11B. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g}(for co-polarized or dual-polarized respectively), i.e., P_{CSIRS,g}=s_{g}N_{1,g}N_{2,g} where s_{g}=1 or 2.

In one example, an antenna group corresponds to an antenna panel. In one example, an antenna group corresponds to a TRP. In one example, an antenna group corresponds to an RRH. In one example, an antenna group corresponds to CSI-RS antenna ports of a NZP CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g., comprising a CSI-RS resource set).

In one example, an antenna group corresponds to a reconfigurable intelligent surface (RIS) in which the antenna group can be (re-)configured more dynamically (e.g., via MAC CE and/or DCI). For example, the number of antenna ports associated with the antenna group can be changed dynamically.

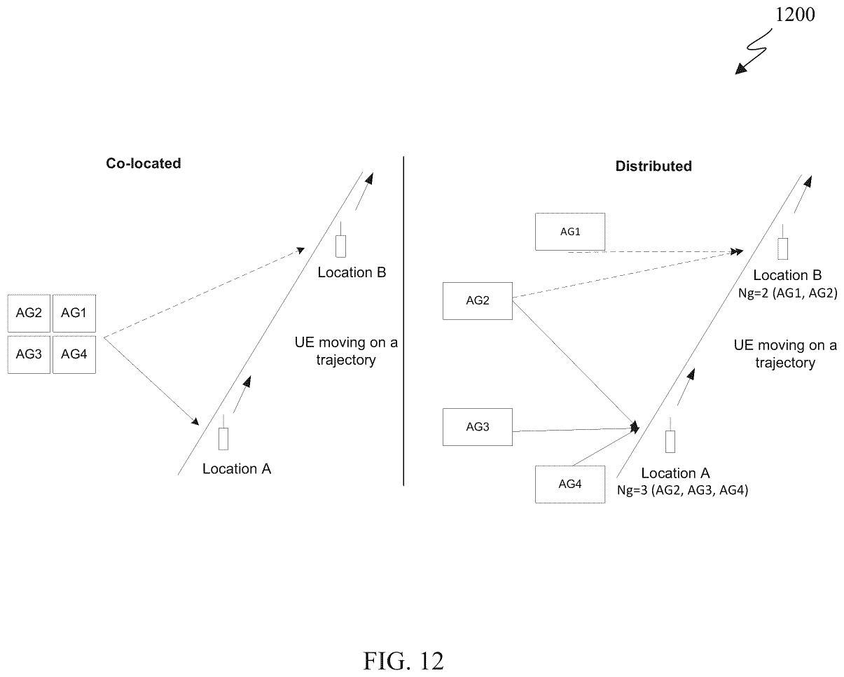

FIG. 12 illustrates co-located and distributed AGs or PGs serving a moving UE 1200 according to embodiments of the present disclosure. The embodiment of the co-located and distributed AGs or PGs serving a moving UE 1200 illustrated in FIG. 12 is for illustration only. FIG. 12 does not limit the scope of this disclosure to any particular implementation of the co-located and distributed AGs or PGs serving a moving UE 1200.

In one example scenario, multiple AGs or PGs can be co-located or distributed, and can serve static (non-mobile) or moving UEs. An illustration of PGs serving a moving UE is shown in FIG. 12. While the UE moves from a location A to another location B, the UE measures the channel, e.g., via NZP CSI-RS resources, (may also measure the interference, e.g., via CSI-IM resources or CSI-RS resources for interference measurement), uses the measurement to determine/report CSI considering joint transmission from multiple PGs. The reported CSI can be based on a codebook. The codebook can include components considering multiple PGs, and frequency/delay-domain channel profile and time/Doppler-domain channel profile.

In one example, the antenna architecture of the MIMO system is structured. For example, the antenna structure at each PG is dual-polarized (single or multi-panel as shown in FIGS. 11A and 11B. The antenna structure at each PG can be the same. Or the antenna structure at an PG can be different from another PG. Likewise, the number of ports at each PG can be the same. Or the number of ports at one PG can be different from another PG. Likewise, the number of ports at each PG can be the same (e.g., 1 or 2 for FR2 and from a set of values {2, 4, 8, 16, 24, 32, 64, 128, 256} for FR1 or FR3), where FR1 corresponds to frequency band up to 6 GHz and FR3 corresponds to a lower to upper mid-bands. Or the number of ports at one PG can be different from another PG.

In another example, the antenna architecture of the MIMO system is unstructured. For example, the antenna structure at one PG can be different from another PG.

Various embodiments discussed below relate to a structured antenna architecture. For simplicity, each PG is assumed to be equivalent to a panel (cf. FIGS. 11A and 11B), although, an PG can have multiple panels in practice. The disclosure however is not restrictive to a single panel assumption at each PG, and can easily be extended (covers) the case when an PG has multiple antenna panels. In the rest of the disclosure, for FR2, a PG is assumed to correspond to a port or analog beam (cf. FIG. 10), and for FR1, a PG corresponds to multiple ports, e.g., FIGS. 11A and 11B.

In one embodiment, an PG constitutes (or corresponds to or is equivalent to) at least one of the following:
In one example, a PG corresponds to a port or analog beam or a spatial domain measurement unit, e.g., at least in FR2.
In one example, an PG corresponds to a TRP or a panel.
In one example, an PG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure.
In one example, a PG corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in this disclosure. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, a PG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) a PG. The information about the subsets of ports or grouping of ports can be provided together with the CSI-RS resource setting/configuration, or with the CSI reporting setting/configuration, or with the CSI-RS resource configuration.
In one example, a PG corresponds to one of the prior examples depending on a configuration. For example, this configuration can be explicit via a parameter (e.g., an RRC parameter). Or it can be implicit.
   In one example, when implicit, it could be based on the value of K. For example, when K>1 CSI-RS resources, a PG corresponds to one of the prior examples, and when K=1 CSI-RS resource, a PG corresponds to one of the prior examples.
   In another example, the configuration could be based on the configured codebook. For example, a PG corresponds to a CSI-RS resource (one of the prior examples) or resource group (one of the prior examples) when the codebook corresponds to a decoupled codebook (modular or separate codebook for each PG), and a PG corresponds to a subset (or a group) of CSI-RS ports (one of the prior examples) when codebook corresponds to a coupled (joint or coherent) codebook (one joint codebook across PGs).

In one example, when PG maps (or corresponds to) a CSI-RS resource or resource group, and a UE can select a subset of PGs (resources or resource groups) and report the selected PGs via an indicator. For example, the indicator can be a CRI or a PMI (component) or a new indicator, e.g., port group indicator (PGI). This report can be a standalone report. Or it can be a non-standalone report. When non-standalone, it can be reported together with the CSI, e.g., CSI corresponding to the selected PGs.

In one example, when PG maps (or corresponds to) a CSI-RS port group, and a UE can select a subset of PGs (port groups) and report the selected PGs via an indicator. For example, the indicator can be a CRI or a PMI (component) or a new indicator, e.g., PGI. This report can be a standalone report. Or it can be a non-standalone report. When non-standalone, it can be reported together with the CSI, e.g., CSI corresponding to the selected PGs.

In these two examples, the indicator can be a bitmap of length Z, one bit for each PG, where a bit value 1 indicates that the corresponding PG is selected, and a bit value 0 indicates the corresponding PG is not selected. Or, for the selection of k out of Z PGs, the indicator can be a combinatorial indicator taking a value from

$$\{ 0 , 1 , … , ( \begin{matrix}z \\ k\end{matrix} ) - 1 \} .$$

The payload of this indicator is

$$⌈ {log}_{2} ( \begin{matrix}z \\ k\end{matrix} ) ⌉$$

bits.

In one example, a UE is configured to select a set of ports, UE-selected PG, (from a set of fixed or configured (RRC)/indicated(DCI) ports) and report the UE-selected PG via an indicator. For example, the indicator can be a CRI or a PMI (component) or a new indicator, e.g., PGI. This report can be a standalone report. Or it can be a non-standalone report. When non-standalone, it can be reported together with the CSI, e.g., CSI corresponding to the selected ports. In one example, the indicator can be a bitmap of length Z, one bit for each port, where a bit value 1 indicates that the corresponding port is selected, and a bit value 0 indicates the corresponding port is not selected. Or, for the selection of k out of Z ports, the indicator can be a combinatorial indicator taking a value from

$$\{ 0 , 1 , … , ( \begin{matrix}z \\ k\end{matrix} ) - 1 \} .$$

The payload of this indicator is

$$⌈ {log}_{2} ( \begin{matrix}z \\ k\end{matrix} ) ⌉$$

bits.

In one example, the indicator (for the selection) takes a value from {0,1, . . . , P−1}. The payload of this indicator is ┌log₂ P┐ bits, where P is a number of candidates/hypotheses for the selection. In one example, the set of candidates/hypotheses is fixed or configured (RRC) or indicated via DCI or/and MACE CE. In one example, the value of P is fixed or configured (RRC) or indicated via DCI or/and MACE CE. In one example, any one of or both of the value of P and the set of candidates/hypotheses are fixed or configured (RRC) or indicated via DCI or/and MACE CE.

In one example, for CSI, when multiple (K>1) RSs (or CSI-RSs, or resources or resource Ids) are configured for N_{g} PGs (example A.2/3), a decoupled (modular) codebook is used/configured, and when a single (K=1) RS (e.g., CSI-RS or resource) for N_{g} PGs (example A.4), a joint codebook is used/configured. In one example, an RS corresponds to a 1-port RS. In one example, an RS corresponds to a X-port RS, where X=1 or 2. In one example, an RS corresponds to a X-port RS, where X ∈S, and S is a set of values, e.g. {1, 2, 3, 4, 6, 8, 12, 16, 24, 32, . . . }.

In one embodiment, a UE is configured (e.g., via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

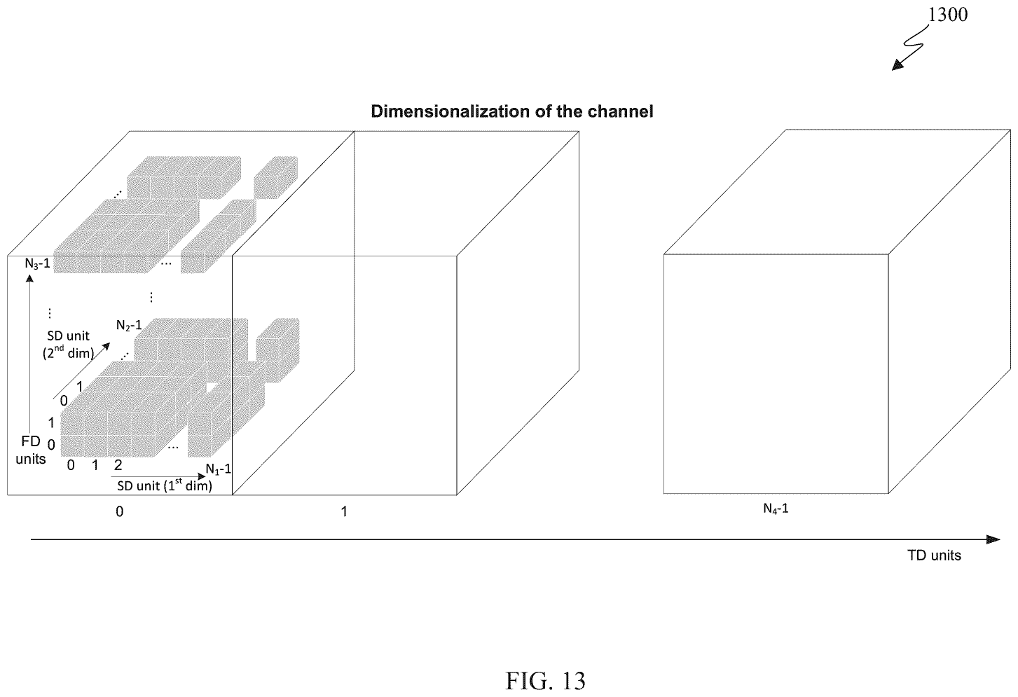

FIG. 13 illustrates an example of RBs 1300 in a channel according to embodiments of the present disclosure. The embodiment of the RBs 1300 illustrated in FIG. 13 is for illustration only. FIG. 13 does not limit the scope of this disclosure to any particular implementation of RBs.

In one embodiment, a UE is configured (e.g., via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

The channel measurement can be based on K≥1 channel measurement resources (CMRs) that are transmitted from a plurality of spatial-domain (SD) units (e.g., a SD unit=a CSI-RS antenna port), and are measured via a plurality of frequency-domain (FD) units (e.g., a FD unit=one or more PRBs/SBs) and via either a time-domain (TD) unit or a plurality of TD units (e.g., a TD unit=one or more time slots). In one example, a CMR can be a NZP-CSI-RS resource.

Or, the channel measurement can be based on a configuration of P≥1 ports or measurement ports or channel measurement ports (CMPs) associated with one or more measurement RSs (e.g., NZP CSI-RSs) that are transmitted from one or a plurality of spatial-domain (SD) units (e.g., a SD unit=a port or a beam or analog beam or a CSI-RS antenna port), and are measured via a plurality of frequency-domain (FD) units (e.g. a FD unit=one or more PRBs/SBs) and via either a time-domain (TD) unit or a plurality of TD units (e.g., a TD unit=one or more time slots). In one example, a CMR can be a NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) or/and a second set of TD units (different from the plurality of TD units associated with the channel measurement). In this later case, the UE, based on the channel measurement, can perform prediction (interpolation or extrapolation) in the second set of FD units or/and the second set of TD units associated with the CSI report.

An illustration of the SD units (in 1^{st} and 2^{nd} antenna dimensions), FD units, and, and TD units is shown in FIG. 13.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g., co-located at one site or distributed across multiple sites) comprising one or multiple antenna groups (i.e., N_{g}≥1), and dimensionalizes the spatial-domain profile of the channel measurement.

When K=1, there is one CMR comprising P_{CSIRS} CSI-RS antenna ports. For the latter:
When N_{g}=1, there is one PG comprising all P_{CSIRS} ports, and the CSI report is based on the channel measurement from the one PG.
When N_{g}>1, there are multiple PGs, and the CSI report is based on the channel measurement from/across the multiple PGs.

In one example, K=1 is fixed. In one example, K=1 is fixed for FR2. In one example, K=1 is fixed for FR2 and can be 1 or >1 for FR1 or FR3.

When K>1, there are multiple CMRs, and the CSI report is based on the channel measurement across the multiple CMRs. In one example, a CMR corresponds to an AG (one-to-one mapping). In one example, multiple CMRs can correspond to an AG (many-to-one mapping).

In one example, when all of the P_{CSIRS} antenna ports are co-located at one site, N_{g}=1. In one example, when all of the P_{CSIRS} antenna ports are distributed (non-co-located) across multiple sites, N_{g}>1.

In one example, when all of the P_{CSIRS} antenna ports are co-located at one site and within a single antenna panel, N_{g}=1. In one example, when all of the P_{CSIRS} antenna ports are distributed across multiple antenna panels (can be co-located or non-co-located), N_{g}>1.

The value of N_{g} can be configured, e.g., via higher layer RRC parameter. Or it can be indicated via a MAC CE. Or it can be provided via a DCI field.

Likewise, the value of K can be configured, e.g., via higher layer RRC parameter. Or it can be indicated via a MAC CE. Or it can be provided via a DCI field.

In one example, K=N_{g}=X. The value of X can be configured, e.g., via higher layer RRC parameter. Or it can be indicated via a MAC CE. Or it can be provided via a DCI field.

In one example, the value of K is determined based on the value of N_{g}. In one example, the value of N_{g} is determined based on the value of K.

In one example, K is number of ports/beams for port/beam (selection of ports/beams from a set of configured/indicated ports/beams) reporting in FR2, i.e., there is no PG for beam reporting. In one example, K=N_{g} for CSI (PMI/CQI/RI) reporting in FR2, i.e., there can be PG for CSI reporting. This PG can be indicated to the UE for the CSI reporting (e.g., via DCI triggering the CSI report).

The plurality of FD units can be associated with a frequency domain allocation of resources (e.g., one or multiple CSI reporting bands, each comprising multiple PRBs) and dimensionalizes the frequency (or delay)-domain profile of the channel measurement.

The plurality of TD units can be associated with a time domain allocation of resources (e.g., one or multiple CSI reporting windows, each comprising multiple time slots) and dimensionalizes the time (or Doppler)-domain profile of the channel measurement.

In one example, the CSI report includes an information about N≥1 port(s)/beam(s) selected out of K beams/ports (e.g., the information can be a joint indicator or multiple indicators indicating selected port(s)/beams(s)). The information can further include a metric (e.g., L1-RSRP, L1-SINR) associated with each of the N port(s)/beams(s) or a common metric (one value) for all N port(s)/beam(s).

In the rest of disclosure, the selected N port(s)/beam(s) is also referred to a (port or PG selection) hypothesis. This is in particular applicable to FR2. Also, when the selected N ports comprising a hypothesis is reported by the UE, it corresponds to or referred to as UE-reported port or PG selection hypothesis (via UCI). Likewise, when the selection of ports/beams comprising a hypothesis is indicated from the NW to the UE (e.g., via DCI), it corresponds to or referred to as NW-controlled port or PG selection hypothesis (similar to TCI state indication via code points of a DCI field in a DCI).

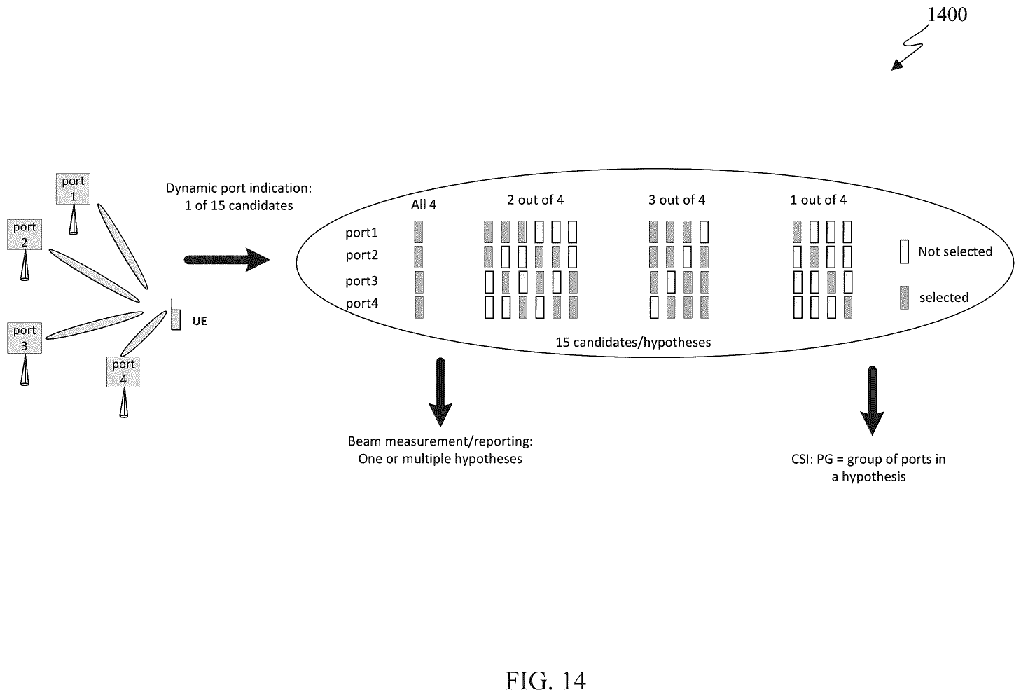

FIG. 14 illustrates an example of port or beam selection 1400 according to embodiments of the present disclosure. The embodiment of the port or beam selection 1400 illustrated in FIG. 14 is for illustration only. FIG. 14 does not limit the scope of this disclosure to any particular implementation of port or beam selections.

An example is shown in FIG. 14 wherein there are 4 ports/beams, and 15 candidates/hypotheses for selecting one or more ports/beams out of the 4 beams/ports. When one of the 15 candidates is indicated (e.g., via a 4-bit bitmap or/and up to 4 TCI states or 1 TCI state with up to 4 source RS, each source RS corresponds to a beam/port) then the CSI or DL transmission corresponds to the PG comprising a group of port(s) based on the indicated ports. Depending on the frequency band and antenna architecture (fully digital vs hybrid), the port can be with a fixed beam/virtualization, or a dynamic beam/virtualization. When dynamic, the port/beam indication can be based on a TCI state indicating source RS(s) and associated a QCL property (e.g., TypeA or/and TypeD).

In one example, as shown in FIG. 14, when 1 PG=1 port/beam, a candidate/hypothesis essentially corresponds to a port selection (for reporting by the UE or indication from the NW), where the port selection corresponds to selecting one or multiple ports.
In one example, for beam reporting, the UE is configured to report a hypothesis with a number of selected ports/beams X being:
   In one example, fixed, e.g., 1 or 2.
   In one example, configured, from a set of supported values such as {1, 2, . . . }.
   In one example, is up to UE, i.e., the UE selects any value of X (e.g., via part 1 of a two-part UCI).
In one example, for beam reporting, the UE is configured to report a γ≥1 hypotheses, where
   In one example, γ is fixed.
   In one example, γ is RRC configured.
   In one example, γ is reported by the UE (e.g., via part 1 of a two-part UCI).

In one example, the UE is configured (for the purpose of CSI measurement and reporting) with P ports/beams, and the P ports/beams are grouped into N_{g} PGs (each with, e.g.,

$$\frac{P}{{N}_{g}}$$

ports or Pᵢ ports such that P=Σᵢ^{N}^{_{g}} Pᵢ). Then, the UE measures the P ports/beams and reports a CSI (e.g., including at least one of CQI/PMI/RI) and PGI.
In one example, the UE reports one (CSI, PGI).
In one example, the UE reports T≥1 pairs (CSI, PGI). The value of T can be fixed, or configured (e.g., via RRC) or indicated via MAC CE or DCI (e.g., via DCI triggering the AP CSI report).

In one example, the usage of the entity PG is needed only for CSI reporting (with or without PGI).
In one example, the CSI corresponds to a Type-II CJT (e.g., as in Rel-18 Type II-CJT in 5G NR, section 5.2.2.2, 38.214)
In one example, the CSI corresponds to a CSI associated with a sector (e.g., in case of virtual sectorization using PGs), where the sector corresponds to a PG. In this case, each report includes both CSI and associated with PGI.
In one example, the CSI corresponds to a CJT calibration reporting (e.g., as in Rel-19 time/frequency/phase calibration reporting of 5G NR).
In one example, the CSI to corresponds a CSI for duplex (e.g., Rel-18/19 SBFD in 5G NR).

In one example, the PG-based entity can be used to facilitate a multi-hypothesis CSI reporting (i.e., for informing/reporting the NW of the implications of different port/PG selection hypotheses). Such a reporting is beneficial for NW energy saving.

In one example, depending on available duplex (e.g., SBFD) antenna configuration (shared vs separate panels or antenna ports), we can have two modes/hypotheses for MIMO operations.
Mode 1: separate handling of CSI/TCI/QCL/SRS for SBFD and non-SBFD slots
Mode 2: joint handling of at least some of CSI/TCI/QCL/SRS across SBFD and non-SBFD slots

This implies that multi-hypothesis CSI reporting is needed for accommodating potentially different antenna configurations (hence potentially different number of ports and CSI-RS resource configurations, codebooks or SRS configurations including SRS antenna switching, CQI calculation) for SBFD and non-SBFD slots. The CSI for duplex essentially corresponds to multi-hypothesis CSI, e.g., CSI for duplex operation such as Rel-18/19 SBFD DL/UL slot or CSI for non-duplex (i.e., DL only slot). The PG-based entity can be used for supporting duplex operations at NW via PMI-based or reciprocity/SRS-based DL precoding.

In various embodiments, the CSI report includes an information about a precoding matrix (e.g., the information is an indicator such as PMI). The information about the precoding matrix comprises/includes at least two components (W₁ and W₂). The first component (W₁) includes a basis which corresponds to a set of basis entities. The second component (W₂) includes combining coefficients which linearly combine the basis entities, i.e., the precoding matrix can be represented as a weighted summation over the basis entities, where the weights are the combining coefficients.

The first component W₁ is codebook-based. When the basis needs reporting (or configured to be reported), the codebook configured for the CSI report includes at least one component for reporting the basis W₁. This component is similar to other (e.g., Type I and II codebooks in 5G NR) codebooks. However, since W₁ is decoupled from W₂, the framework allows more options and parameterization for the W₁ basis as future upgrades when newer antenna types become available.

The second component (W₂) is also codebook-based and is derived based on the channel measurement and W₁. For instance, the channel measurement can be projected on to the basis W₁ and projected channel can be used to derive the W₂ combining coefficients based on a machine-learning (ML) or artificial intelligence (AI) approach which is agnostic to antenna structure/geometry/dimension, implying there may be no (or less) need for upgrades for more futuristic scenarios. The convolutional-based W₂ is expected to achieve higher resolution (than for example, Type II codebooks in 5G NR), with less decoding complexity. Such an approach may require a mechanism to train/adapt the W₂ coefficients (albeit less often), which can be facilitated by having a codebook-based W₂ also. This can be based on Type I or Type II codebooks in 5G NR, and can also serve as a fallback to the legacy (codebook-based) W₂ coefficients. This fallback components is denoted as W_{2,FB} and the codebook configured for the CSI report includes at least one component for reporting W_{2,FB}.

In one example, the CSI report is based on the convolutional-based W₂ unless configured otherwise (i.e., the UE is configured to use W_{2,FB} or W_{2,FB} is enabled). In one example, the UE is configured with one of W₂ and W_{2,FB} for the CSI report (e.g., via RRC or/and MAC CE or/and DCI). In one example, the baseline for the CSI report is W_{2,FB} (i.e., the UE is mandated to support it), and the support of W₂ is optional (i.e., subject to UE capability); when the UE reports being capable of supporting W₂, then only the UE can be configured with the CSI report based on W₂.

The basis can be selected by the UE (hence reported, e.g., via the CSI report) or configured by the NW. When configured, the UE can use the configured basis to derive the CSI report, or use the configured basis to determine the basis for reporting, for example, the configured basis can be included an intermediate set of basis entities, and the UE uses this intermediate set to determine the basis for reporting. In one example, the intermediate set corresponds to a window of (consecutive) basis entities.

In one example, the CSI report includes an information about a precoding matrix (e.g., the information is an indicator such as PMI). The information about the precoding matrix comprises/includes at least two components (W₁ and W₂). The first component (W₁) includes a basis which corresponds to a set of basis entities. The second component (W₂) includes
For low-resolution (Type I), selection of a basis entity from the basis entities (per layer) and co-phasing across two polarizations.
For high-resolution (Type II), combining coefficients which linearly combine the basis entities, i.e., the precoding matrix can be represented as a weighted summation over the basis entities, where the weights are the combining coefficients.

The first component W₁ is codebook-based. When the basis needs reporting (or configured to be reported), the codebook configured for the CSI report includes at least one component for reporting the basis W₁. This component is similar to legacy (e.g., Type I and II codebooks in 5G NR) codebooks. However, since W₁ is decoupled from W₂, the framework allows more options and parameterization for the W₁ basis as future upgrades when newer antenna types become available. The basis can be dictated by (or associated with) at least one of the spatial-domain profile, frequency (or delay)-domain profile, or time (Doppler)-domain profile of the channel measurement. Even though the number of CSI-RS antenna ports can be large (e.g. 256), the antenna ports are expected to have some antenna structure (e.g. similar to 2D active antenna array), hence the SD channel profile can be represented using SD basis entities, where the SD basis entities have dimension depending on the number of SD units

$$( {P}_{CSIRS} or \frac{{P}_{CSIRS}}{2} or 2 {N}_{1} {N}_{2} or {N}_{1} {N}_{2} ) .$$

Likewise, the FD channel profile is likely to be correlated across FD units, and the DD/TD channel profile is also expected to have some correlation across DD/TD units (e.g., for low-medium speed UEs). Hence, FD and DD/TD channel profiles can be represented using FD and DD/TD basis entities, respectively, where their dimensions depend on the number of FD units (N₃) and the number of DD/TD units (N₄), respectively.

The second component (W₂) is also codebook-based and is derived based on the channel measurement and W₁. For instance, the channel measurement can be projected on to the basis W₁ and projected channel can be used to derive the W₂ components (coefficients), e.g., based on Type I or Type II codebooks in 5G NR.

In one example, the number of antenna ports across K CSI-RS resources is the same. For example, each of the K CSI-RS resources can be associated with 2N₁N₂ antenna ports. In this case, the total number of antenna ports is P_{CSIRS,tot}=2KN₁N₂.

In one example, the number of antenna ports across K CSI-RS resources can be the same or different. For example, each of the K CSI-RS resources can be associated with 2N_{1,r}N_{2,r} antenna ports. In this case, the total number of antenna ports is P_{CSIRS,tot}=Σᵣ₌₁^{K}2N_{1,r}N_{2,r}.

In port numbering scheme 1, the CSI-RS ports are numbered according to the order of (polarization p, NZP CSI-RS resource r) as CSI-RS ports of (p=0,r=1) followed by CSI-RS ports of (p=1, r=1), followed by CSI-RS ports of (p=0, r=2), followed by CSI-RS ports of (p=1,r=2), . . . , followed by CSI-RS ports of (p=0, r=N) followed by CSI-RS ports of (p=1,r=N).

In port numbering scheme 2, the CSI-RS ports are numbered according to the order of (polarization p, NZP CSI-RS resource r) as
CSI-RS ports of (p=0,r=1) followed by CSI-RS ports of (p=0,r=1), . . . , followed by CSI-RS ports of (p=0,r=N), and
then CSI-RS ports of (p=1, r=1) followed by CSI-RS ports of (p=1, r=1), . . . , followed by CSI-RS ports of (p=1, r=N).

In one example, an PG corresponds to an antenna, an antenna group (multiple antennae), an antenna port, an antenna port group (multiple ports), a CSI-RS resource, a CSI-RS resource set, a group of CSI-RS resources, a panel, an RRH, a Tx-Rx entity, a (analog) beam, a (analog) beam group, a cell, a cell group.

In one example, PGs can have a uniform (the same/common) structure. For example, they can have the same number of ports (P_{CSIRS,r}=P_{CSIRS}) or the same antenna port layout (N_{1,r}, N_{2,r})=(N₁, N₂). In one example, PGs can have non-uniform (or different) structure. For example, they can have the same or different number of ports (P_{CSIRS,r}_{₁}=P_{CSIRS,r}_{₂} or P_{CSIRS,r}_{₁}≠P_{CSIRS,r}_{₂}) or the same antenna port layout, i.e., (N_{1,r}_{₁}, N_{2,r}_{₁})=(N_{1,r}_{₂}, N_{2,r}_{₂}) or (N_{1,r}_{₁}, N_{2,r}_{₁})≠(N_{1,r}_{₂}, N_{2,r}_{₂}).

Let γ≥1 be a number of port or PG selection hypotheses. For each l ∈{1, . . . , γ}, an port or PG selection hypothesis selects nₗ port or PGs, where 1≤nₗ≤N_{AG}. In one example, when nₗ=N_{AG}, the selection (or corresponding hypothesis) can be referred to as a full-coherent (FC). In one example, when 1<nₗ<N_{AG}, the selection (or corresponding hypothesis) can be referred to as a partial-coherent (PC). In one example, when nₗ=1, the selection (or corresponding hypothesis) can be referred to as a non-coherent (NC).

In one embodiment, for the port or PG selection, a UE can be configured with N_{AG}≥1 ports or PGs (e.g., via an IE such as NZP CSI-RS ports or port groups), for example, via higher layer IE CSI-ResourceConfig or CSI-PortConfig, for channel measurement (CMR). The UE can also be configured with M_{AG}≥1 ports or PGs (e.g., CSI-IM ports or port groups or ZP CSI-RS ports or port groups or NZP CSI-RS ports or port groups) for interference measurement (IMR). In one example, M_{AG}=1 regardless of the value of N_{AG}. In one example, M_{AG}=N_{AG}. In one example, there is one-on-one mapping between M_{AG} PGs for IMR and N_{AG} PGs for CMR.

In one example, the port or PG selection can be a standalone/separate procedure.
In one example, the port or PG selection corresponds to a report, i.e., can be performed by the UE and reported to the NW, e.g., via an information (e.g., one or multiple indicators or bitmaps) about the γ PG selection hypotheses (similar to beam or CSI report). In one example, γ is fixed, e.g., γ=ν. In one example, γ is configured to the UE (e.g., via RRC or MAC CE or DCI). In one example, γ is reported by the UE (e.g., via a report, or UE capability reporting). In one example, γ=ν, a number of layers (i.e., rank value).
In one example, the port or PG selection corresponds to a port/beam indication, i.e., can be configured/indicated to the UE. For example, this can be based on an existing entity (e.g., QCL-Info, or TCI State), or a new entity. This indication can be higher layer configured, or indicated via MACE CE or DCI (e.g., DL-DCI or UL-DCI) (similar to beam/TCI state indication). For example, of a set of ports/beams or TCI states (associated with or configured for ports/beams) can be configured and a TCI field in DCI can be used to indicate the port/beam indication.

In one example, the port or PG selection can be a non-standalone procedure.
In one example, when NW-indicated, the port or PG selection is included or/and multiplexed with a DL indication such as beam or TCI state indication.
   In one example, it is included in (or as a component of) the TCI state definition or QCL-Info.
   In one example, it is included as a new IE or parameter (not included in TCI state or QCL-Info).
   In one example, it is included in a new or existing DCI field or code point (of a DL-DCI or UL-DCI).
   In one example, it is included in a new or existing MAC CE field or code point.
In one example, when UE-reported, the port or PG selection is included or/and multiplexed with a report (e.g., CSI or beam report or TDCP report).
   In one example, it is included in (or as a component of) a CSI parameter (e.g., PMI i1 or/and i2, or RI, or CRI).
   In one example, it is included as a new IE or parameter (e.g., PGI, ASI, antenna selection indicator).

At least one of the following examples can be used/configured regarding the content of the port or PG selection report.
In one example, the content includes an information I (e.g., an indicator or a bitmap) about the selected {nₗ} ports or PGs that is common/same for all 1.
In one example, for each 1, the content includes an information Iₗ (e.g., an indicator or a bitmap) about the selected {nₗ} ports or PGs.
In one example, the content includes (i) I or {Iₗ}, as described above, and (ii) a value of a metric M (e.g., L-RSRP, power level, L1-SINR, CQI, BLER etc.).
In one example, the content includes (i) I or {Iₗ}, as described above, and (ii) for each 1, a value of a metric Mₗ(e.g., L1-RSRP, power level, L1-SINR, CQI, BLER etc.).

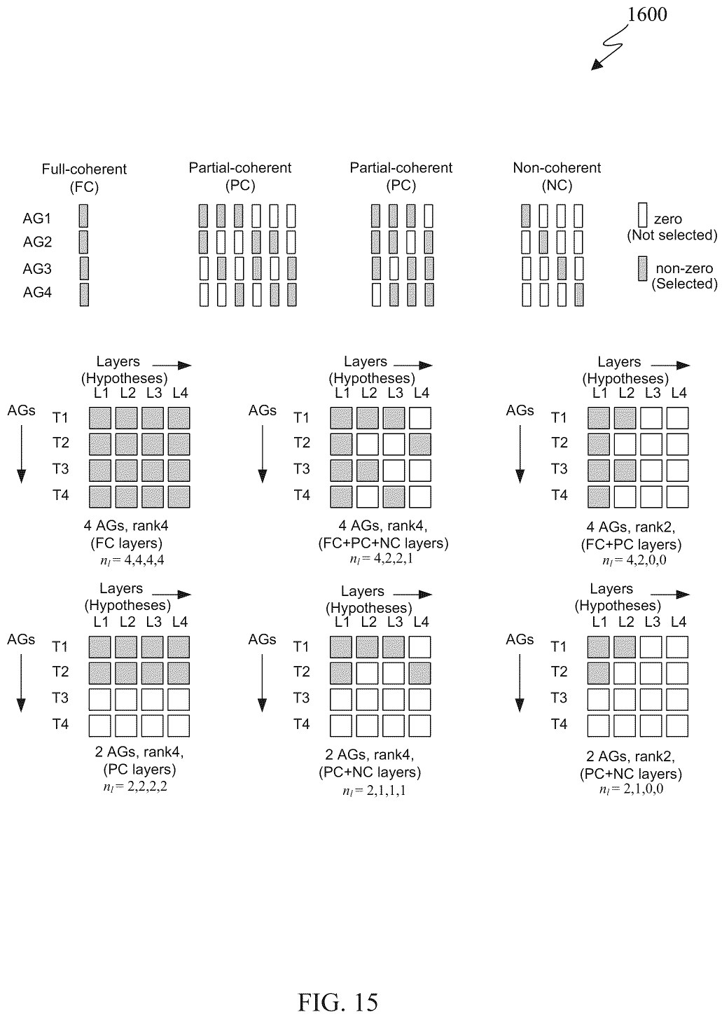

FIG. 15 illustrates examples of AG selection hypotheses 1500 according to embodiments of the present disclosure. The embodiment of the AG selection hypotheses 1500 illustrated in FIG. 15 is for illustration only. FIG. 15 does not limit the scope of this disclosure to any particular implementation of AG selection hypotheses.

In one embodiment, a UE can be configured with N_{AG}≥1 ports or PGs (e.g., NZP CSI-RS port groups), for example, via higher layer IE CSI-ResourceConfig or CSI-PortConfig. The UE can also be configured with a CSI report (via higher layer IE CSI-ReportConfig) that is linked to the N_{AG} ports or PGs for channel measurement (CMR). For instance, an ID of a set/list including the N_{AG} ports or PGs or a set/list of the IDs of the N_{AG} ports or PGs or a list/set of IDs of the CSI-RS ports comprising the N_{AG} ports or PGs can be included in the CSI-ReportConfig.

The UE can also be configured with M_{AG}≥1 ports or PGs (e.g., CSI-IM port groups or ZP CSI-RS port groups or NZP CSI-RS port groups) for interference measurement (IMR). For instance, an ID of a set/list including the M_{AG} ports or PGs or a set/list of the IDs of the M_{AG} ports or PGs or a list/set of IDs of the CSI-IM/CSI-RS ports comprising the M_{AG} ports or PGs can be included in the CSI-ReportConfig. In one example, M_{AG}=1 regardless of the value of N_{AG}. In one example, M_{AG}=N_{AG}. In one example, there is one-on-one mapping between M_{AG} ports or PGs for IMR and N_{AG} ports or PGs for CMR.

Let ν be a number of layers (i.e., rank value) associated with the CSI report. Let γ≤ν. For a layer l ∈{1, . . . , ν}, the UE can select nₗ ports or PGs, where 1≤nₗ≤N_{AG}, and the CSI report is conditioned on (based on) the selected {nₗ} ports or PGs. An example is illustrated in FIG. 15 for N_{AG}=4. In one example, when nₗ=N_{AG}, the selection is referred to as a full-coherent (FC), and the corresponding precoder is a FC precoder. when 1≤nₗ≤N_{AG}, the selection is referred to as a partial-coherent (PC), and the corresponding precoder is a PC precoder. Two examples of PC precoders are shown. In one example, when nₗ=1, the selection is referred to as a non-coherent (NC), and the corresponding precoder is a NC precoder.

In one example, the port or PG selection is according to at least one of the following examples.

In one example, the port or PG selection is based on a set of values S₁ for the value of nₗ. The notation A⊆B refers to a subset A of a set B, i.e., A includes all of or some of the values in B.
In one example,

$${S}_{1} ⊆ \{ {N}_{AG} , \frac{{N}_{A G}}{2} , 1 \} ,$$

which correspond to three hypotheses {FC, PC, NC}, respectively.
In one example,

$${S}_{1} ⊆ \{ {N}_{AG} , \frac{{N}_{A G}}{2} , \frac{{N}_{A G}}{4} , 1 \} ,$$

which correspond to four hypotheses {FC, PC1, PC2, NC}, respectively, where PC1 and PC2 are two different PC hypotheses.
In one example,

$${S}_{1} ⊆ \{ \frac{{N}_{A G}}{{2}^{r}} : r = 0 , 1 , … , {log}_{2} {N}_{A G} \} .$$

In one example, S₁ c {1, 2, 4, 8, 12, 16, 24, 32}.
In one example, S G {{1, . . . , P_{CSIRS}}.

In one example, the port or PG selection is based on a restriction, which results in a set of possible hypotheses or patterns S₂.
In one example, the restriction corresponds to nₗ=n for all 1 values (same number of ports or PGs for all layers). The coherence type is the same for all layers, but the selected ports or PGs can be different across layers.
In one example, the restriction corresponds to nₗ=n and the selected n ports or PGs are the same/common across all 1 values (same/common set of ports or PGs are selected for all layers). The coherence type is the same for all layers; in addition, the selected ports or PGs are also the same across layers.

In one example, the port or PG selection is unrestricted, i.e., the UE can select any nₗ ports or PGs for any layer l.

In one example, the UE is configured to report an information about the selected ports or PGs according to at least one of the following examples. This information can be via a dedicated indicator (e.g., included in PMI or/and RI) or via a UCI parameter (e.g., included in UCI part 1 of a two-part UCI).
In example, when the port or PG selection is based on the set of values S₁, an indicator/parameter requiring α┌log₂|S₁|┐ bits can be used, where |S₁| denotes the number of values in S₁ and 1≤α≤ν.
In example, when the port or PG selection is based on the restriction or the set S₂, an indicator/parameter requiring α┌log₂|S₂|┐ bits can be used, where 1≤α≤ν.
In one example, when the port or PG selection is free, a bitmap can be used to report the information. In one example, the bitmap comprises N_{AG}ν bits.
In one example, when the port or PG selection is free, a combinatorial indicator can be used to report the information. In one example, the indicator comprises

$$υ ⌈ {log}_{2} \vert {N}_{A G} \vert ⌉ + {Σ}_{l = 1}^{υ} ⌈ {log}_{2} ( \begin{matrix}{N}_{A G} \\ {n}_{l}\end{matrix} ) ⌉$$

bits.

For example, the bitmap whose nonzero bits identify which ports or PGs are selected/reported, can be indicated by an indicator/parameter i_{1,x}

$${i}_{1 , x} = [ {k}_{1} … {k}_{υ} ]$$

$${k}_{l} = [ {k}_{1 , l} … {k}_{{N}_{AG} , l} ]$$

$${k}_{r , l} ∈ \{ 0 , 1 \}$$

$$Or ,$$

$${i}_{1 , x} = [ {k}_{1} … {k}_{{N}_{A G}} ]$$

$${k}_{r} = [ {k}_{r , 1} … {k}_{r , υ} ]$$

$${k}_{r , l} ∈ \{ 0 , 1 \}$$

Likewise, for example, the combinatorial indicator identifying which ports or PGs are selected/reported, can be indicated by two indicators/parameters i_{1,x} and i_{1,y}

$${i}_{{1}_{λ} y} = [ {g}_{1} … {g}_{v} ] {i}_{1 , x} = [ {k}_{1} … {k}_{v} ]$$

Or one indicator i_{1,x},

$${i}_{1 , x} = [ G , K ]$$

$$G = [ {g}_{1} … {g}_{υ} ]$$

$$K = [ {k}_{1} … {k}_{υ} ]$$

$$Where$$

$${g}_{l} ∈ \{ 0 , 1 , … , {N}_{A G} - 1 \}$$

$${n}_{l} = {g}_{l} + 1$$

$${k}_{l} ∈ \{ 0 , 1 , … , ( \begin{matrix}{N}_{AG} \\ {n}_{l}\end{matrix} ) - 1 \}$$

In one example, K^{sel}=Σᵣ₌₁^{N}^{_{AG}} Σₗ₌₁^{ν}k_{r,l}≤K₀^{sel}, where K₀^{sel} is an upper bound (max value of the total number of selected ports or PGs across all layers. The value K₀^{sel} can be fixed

$$( e . g . , {K}_{0}^{s e l} = {N}_{A G} or \frac{{N}_{A G}}{2} ) ,$$

or configured (via higher layer), or reported by the UE.

In one example, the UE is configured to report the information about the port or PG selection, where the value n₁ is fixed, or configured to the UE. In this case, the UE reports the information including the indices of nₗ PGs selected for layer l.

In one example, the UE is configured to report the information about the PG selection, where the value nₗ is subject to an upper bound, i.e., nₗ≤nₘₐₓ where nₘₐₓ can be fixed, or configured to the UE. In this case, the UE reports the information including the value of nₗ satisfying the upper bound and the indices of nₗ ports or PGs selected for layer l.

At least one of the following examples is used/configured for the selection.
In one example, the selection can be performed by the UE, and reported via the CSI report (via a dedicated indicator/parameter or implicitly/jointly via another indicator/parameter).
In one example, the port or PG selection can be turned ON/OFF via a higher layer signaling. When tuned OFF, the UE uses all N_{AG} ports or PGs or a fixed number of ports or PGs for the CSI report. When tuned ON, the UE performs the port or PG selection, as described above. This switching (ON/OFF) can be based on a dedicated RRC parameter. Or it can be implicitly based on a parameter. For instance, the value of nₗ can be configured. When nₗ=N_{AG}, the port or PG selection is turned OFF, else (nₗ<N_{AG}) it is turned ON. Alternatively, the port or PG selection can be turned ON/OFF via a MACE CE (activation command). Or the port or PG selection can be turned ON/OFF via a DCI (e.g., a DCI request field that triggers the CSI report can also indicate the ON/OFF; else a dedicated DCI field or a reserved code point of an existing DCI field can be used).
In one example, the selection can be performed by the NW/gNB, and can be provided to the UE, e.g., via higher layer or MAC CE or DCI (e.g., UL-DCI carrying the CSI request field).

In one example, when ν≥2, at least one of the following examples is used/configured for the selection (the value nₗ or/and indicates of nₗ selected ports or PGs).
In one example, the selection can be layer-common, i.e., the nₗ=n ports or PGs are selected common/same for all layers.
In one example, the selection can be layer-pair-specific, i.e., for each layer pair {(1,2), (3,4), . . . }, the selected ports or PGs are the same/common, but they can be different across two layer pairs.
In one example, the selection can be rank-common. The nₗ=n ports or PGs are selected common/same for all rank values.
In one example, the selection can be layer-common and RI-common (i.e., the selected ports or PGs are the same/common for all layers or/and rank values).
In one example, the selection can be layer-specific and RI-common (i.e., for a given layer l, the selected ports or PGs are the same/common for all rank values, but for a given rank, the selected ports or PGs can be different across layers).
In one example, the selection can be layer-common and RI-specific (i.e., for a rank, the selected ports or PGs are the same/common for all layers, but for a given layer l, the selected ports or PGs can be different across rank values).
In one example, the selection can be layer-specific and RI-specific (i.e., the selected ports or PGs can be different across rank and layer values).
In one example, the selection can be layer-pair-common and RI-common (i.e., the selected ports or PGs are the same/common for all layer pairs or/and rank values).
In one example, the selection can be layer-pair-specific and RI-common (i.e., for a given layer pair, the selected ports or PGs are the same/common for all rank values, but for a given rank, the selected ports or PGs can be different across layers).
In one example, the selection can be layer-pair-common and RI-specific (i.e., for a rank, the selected ports or PGs are the same/common for all layers, but for a given layer pair, the selected ports or PGs can be different across rank values).
In one example, the selection can be layer-pair-specific and RI-specific (i.e., the selected ports or PGs can be different across rank and layer values).

In one example, when an port or PG comprises multiple antenna ports, for example, AG r comprises P_{CSIRS,r}>1 ports, the selection (described above) can be extended to (A) port or PG selection or/and (B) antenna port selection (within an port or PG). For each hypothesis or layer l, the UE can select nₗ ports or PGs, with indices Rₗ={r⁽¹⁾, . . . , r⁽ⁿ^{ₗ}⁾} where r^{(k}^{ₗ}⁾ ∈{1, . . . , N_{AG}}, and for each of the selected port or PG r ∈ Rₗ, the UE can select pᵣ out of P_{CSIRS,r} ports within the port or PG r.

For frequency range 2 (FR2) or FR4 or a frequency band/carrier>=upper mid-band carrier (e.g. >6 GHz such as 15 GHz), an port or PG can be linked to (associated with) a digital chain (a TXRU or a baseband processing chain), and an antenna port can be a (analog) beam or ‘dynamic virtualization/spatial filter’ (pointing in a certain direction and having a beam-width/spread), which for instance, can be a source RS (e.g. TRS, or NZP CSI-RS, or SSB, or SRS) of a TCI state with QCL typeD (or typeA or type B or typeC). The TCI state can be a legacy Rel.15 TCI state (for DL) or a Rel.15 SpatialRelationInfo (for UL) or Rel.17 unified TCI state (e.g., jointOrDLTCIState or UL-TCIState) as described in Section 5.1.5, 38.214.

In one example, pᵣ=1. Two use cases of one port selection per port or PG can be (source RS) beam/TCI state selection and the port selection codebook when partial reciprocity (e.g., of angle-delay pairs) between DL and UL channels is feasible.
In one example, the port selection depends on the coherence type (FC/PC/NC), described above.
   In one example, when the coherence type is FC (say Type1), one port is selected for each (selected) port or PG, i.e., pᵣ=1 for all r ∈Rₗ.
   In one example, when the coherence type is PC (say Type2), one port is selected for at least two ports or PGs but not all (i.e., <N_{AG}), i.e., pᵣ=1 for at least two values (but not all values) of r ∈Rₗ.
   In one example, when the coherence type is NC (say Type3), one port is selected for one of the (selected) ports or PGs, i.e., pᵣ=1 for only one of r ∈Rₗ.
   In one example, when the coherence type is FC (Type1) or/and PC (Type2), the port selection is according to the corresponding two examples described above.
   In one example, when the coherence type is FC (Type1) or/and NC (Type3), the port selection is according to the corresponding two examples described above.
   In one example, when the coherence type is PC (Type2) or/and NC (Type3), the port selection is according to the corresponding two examples described above.
   In one example, when the coherence type is FC (Type 1) or/and PC (Type2) or/and NC (Type3), the port selection is according to the corresponding three examples described above.
In one example, the UE can be configured with one or multiple coherence types (via higher layer or/and MAC C or/and DCI).
In one example, the UE can report one or multiple coherence types (via CSI report or CSI capability reporting).

In one example, 1≤pᵣ≤P_{CSIRS,r}.
In one example, the port selection depends on the coherence type (FC/PC/NC), described above. The 7 examples above based on the three coherence types can be extended to this case also.
In one example, the UE can be configured with one or multiple coherence types (via higher layer or/and MAC C or/and DCI).
In one example, the UE can report one or multiple coherence types (via CSI report or CSI capability reporting).

In one example, a value of pᵣ is configured (e.g., via RRC or MAC CE or DCI). This value can be the same for all ports or PGs, or can be different/independently configured for each port or PG.

In one example, the port selection (within a port or PG) is controlled by the NW. For instance, the UE can be configured/indicated (by the NW) with an information about the selection of {pᵣ} port(s). The information can provide indices of the selected port(s) for each port or PG. In one example, the information provide both the value of pᵣ and the indices of corresponding selected port(s) for an port or PG r. In one example, the value of pᵣ can be fixed, or configured (e.g., via RRC), and the information provides indices of the selected port(s) for each port or PG r (e.g., via MAC CE or DCI).
In one example, the information is port or PG (group) common, i.e., indices of the selected port(s) is the same/common for all ports or PGs.
In one example, the information is PG (group) specific, i.e., indices of the selected port(s) can be different across ports or PGs, hence provided for each port or PG.

In one example, similar to TCI state indication, a MAC CE or/and DCI based signaling is used/configured to provide the information about the port selection.
In one example, a higher layer RRC parameter can configure a set/list/pool of α≤A ports, and when α>1, a MAC CE can activate/indicate pᵣ of the α configured ports, where A can be fixed

$$( e . g . , 1 , 2 , 4 , 8 , or \frac{{P}_{CSIRS , r}}{2} )$$

or configured (e.g., via higher layer RRC). In one example, A≤P_{CSIRS,r}.
In one example, a MAC CE activation command can activate a subset of α≤A ports, and when α>1, a DCI field can indicate pᵣ of the α activated ports, where A can be fixed

$$( e . g . , 1 , 2 , 4 , 8 , or \frac{{P}_{CSIRS , r}}{2} )$$

or configured (e.g., via higher layer RRC).
In one example, a higher layer RRC parameter can configure a set/list/pool of α≤A ports, and when α>1, a MAC CE activation command can activate a subset of α₁≤α ports, and when α₁>1, a DCI field can indicate pᵣ of the α₁ activated ports, where A can be fixed

$$( e . g . , 1 , 2 , 4 , 8 , or \frac{{P}_{CSIRS , r}}{2} )$$

or configured (e.g. via higher layer RRC). In one example, A=P_{CSIRS,r}.

When the port selection is port or PG-specific, the above examples can be extended by at least one of the signaling component to per port or PG (for each port or PG). The MAC CE or/and DCI based signaling can be via at least one of the following examples.
In one example, it is via an existing signaling.
   In one example, the existing signaling corresponds to (AP or SP) trigger state definition, e.g., by including a new/dedicated parameter or using an existing parameter.
   In one example, the existing signaling corresponds to the CSI request field in UL-DCI (that triggers AP CMR or/and CSI reporting), e.g., by including a new/dedicated parameter or using an existing parameter.
   In one example, the existing signaling corresponds to TCI state definition (Rel.15 TCI state or Rel.17 unified TCI state or a new TCI state definition), e.g., by including a new/dedicated parameter or using an existing parameter.
   In one example, the existing signaling corresponds to QCL-Info (Rel.15 QCL-Info or Rel.17 QCL-Info or a new QCL-Info definition), e.g., by including a new/dedicated parameter or using an existing parameter.
   In one example, the existing signaling corresponds to the MAC CE that activates AP CSI-RS resources, or the MAC CE that activates/maps (up to 8) TCI states to the DCI field in DL-DCI.
   In one example, the existing signaling corresponds to a combination an existing MAC CE (one of the two in previous example) and an existing DCI (one of examples above).
In one example, it is via a new signaling.

A few pertinent use cases of NW-controlled port selection include network energy saving (NES), and RIS.

Similar to the port or PG selection, at least one of the following examples can be used for the port selection.

In one example, the port selection is based on a set of values T₁ for the value of pᵣ.
In one example,

$${T}_{1} ⊆ \{ {P}_{CS1RS , r} , \frac{{P}_{CSIRS , r}}{2} , 1 \} ,$$

which can correspond to three hypotheses {FC, PC, NC}, respectively.
In one example,

$${T}_{1} ⊆ \{ {P}_{CSIRS , r} , \frac{{P}_{CSIRS , r}}{2} , \frac{{P}_{CSIRS , r}}{4} , 1 \} ,$$

which can correspond to four hypotheses {FC, PC1, PC2, NC}, respectively, where PC1 and PC2 are two different PC hypotheses.
In one example,

$${T}_{1} ⊆ \{ \frac{{P}_{CSIRS , r}}{{2}^{r}} : r = 0 , 1 , … , {log}_{2} {P}_{CSIRS , r} \} .$$

In one example, T₁ ⊆{1, 2, 4, 8, 12, 16, 24, 32}.
In one example, T₁ ⊆{{1, . . . , P_{CSIRS,r}}.

In one example, the port selection is based on a restriction, which results in a set of possible hypotheses or patterns T₂.
In one example, the restriction corresponds to pᵣ=p for all r values (same number of ports for all ports or PGs). The coherence type is the same for all layers, but the selected ports can be different across ports or PGs.
In one example, the restriction corresponds to pᵣ=p and the selected p ports are the same/common across all r values (same/common set of ports are selected for all PGs). The coherence type is the same for all ports or PGs; in addition, the selected ports are also the same across ports or PGs.

In one example, the port selection is unrestricted, i.e., the UE can select any pᵣ ports for any port or PG r.

In one example, the UE is configured to report an information about the selected ports according to at least one of the following examples. This information can be via a dedicated indicator (e.g., included in PMI or/and RI) or via a UCI parameter (e.g., included in UCI part 1 of a two-part UCI).
In one example, when the port selection is based on the set of values T₁ (example above), an indicator/parameter requiring N_{AG} ┌log₂|T₁|┐ bits can be used, where |T₁| denotes the number of values in T₁.
In one example, when the port selection is based on the restriction or the set T₂ (Example above), an indicator/parameter requiring N_{AG} ┌log₂|T₂|┐ bits can be used.
In one example, when the port selection is free (example above), a bitmap can be used to report the information. In one example, the bitmap comprises N_{AG} P_{CSIRS,r} or P_{CSIRS} or ΣP_{CSIRS,r} bits. The details are similar to the same for the port or PG selection.
In one example, when the port selection is free (example above), a combinatorial indicator can be used to report the information. The details are similar to the same for the port or PG selection.

In one example, the port selection (within a port or PG) is performed/reported by the UE. For instance, the UE can be configured/indicated (by the NW) to perform the port selection, and the UE in response performs the port selection and reports an information (e.g., indicator(s)) about the selection of {pᵣ} port(s). The information can indicate indices of the selected port(s) for each port or PG. In one example, the information indicates both the value of pᵣ and the indices of corresponding selected port(s) for an port or PG r. In one example, the value of pᵣ can be fixed, or configured (e.g., via RRC), and the information indicates indices of the selected port(s) for each port or PG r.
In one example, the information indicates port or PG (group) common port selection, i.e., indices of the selected port(s) is the same/common for all ports or PGs.
In one example, the information indicates port or PG (group) specific port selection, i.e., indices of the selected port(s) are indicated for each port or PG.

At least one of the following examples is used/configured to indicate the information about the port selection.
In one example, the information includes a port indicator (e.g., a bitmap indicator or a combinatorial indicator), details similar to examples explained above for the port or PG selection.
In one example, the information includes a port indicator and a metric (e.g., RSRP, SINR, CQI, BLER etc.), details similar to examples explained above for the port or PG selection.

Also, when the port selection is together with the port or PG selection (described above),
In one example, the port or PG selection and the port selection are two separate/decoupled mechanisms (either NW-controlled or UE-reported). Hence, the corresponding signaling or/and reporting can be separate.
In one example, the port or PG selection and the port selection can be coupled into one mechanism (either NW-controlled or UE-reported). Hence, the corresponding signaling or/and reporting can be together/joint.

In one example, the information is reported separately (from typical CSI/beam report) via a standalone report. In one example, this report may not be multiplexed with other CSI (or UCI) parameters. In one example, this report can bet be multiplexed with other CSI (or UCI) parameters; however, can't be a part/component of a CSI (or beam) report.

In one example, the information is reported jointly either as a part/component of a CSI (or beam) report, or as a separate UCI parameter or CSI report that can be multiplexed with other CSI (or beam) reports. The report can also be multiplexed other (than CSI) UCI parameters (such as HARQ-ACK).

In one embodiment, the port or PG or/and port selection reporting can be according to at least one of the following examples.
In one example, the information about the selection (as described above) is reported via a one-part UCI transmitted in an UL slot with PUCCH.
In one example, the information about the selection (as described above) is reported via a one-part UCI transmitted in an UL slot with PUSCH.
In one example, the information about the selection (as described above) is reported via a two-part UCI transmitted in an UL slot with PUCCH.
In one example, the information about the selection (as described above) is reported via a two-part UCI transmitted in an UL slot with PUSCH.
In one example, the information about the selection (as described above) is reported via a two-part UCI transmitted in an UL slot with PUCCH and PUSCH.
   In one example, part 1 is via PUCCH and part 2 is via PUSCH.
   In one example, part 1 is via PUSCH and part 2 is via PUCCH.
In one example, the information about the selection (as described above) is reported via a two-part UCI transmitted in two UL slots (consecutive, separate by m slots, where m can be fixed, or configured via RRC or MAC CE or DCI), where part 1 is reported in UL slot 1 and part 2 is reported in UL slot 2.
   In one example, both parts are reported via PUCCH.
   In one example, both parts are reported via PUSCH.
   In one example, part 1 is via PUCCH and part 2 is via PUSCH.
   In one example, part 1 is via PUSCH and part 2 is via PUCCH.
In one example, the information about the selection (as described above) is reported via a three-part UCI.

For two-part UCI, either one UL slot, or two UL slots,
In one example, (UCI part 1, UCI part2) includes (port or PG or/and port selection information, CSI), respectively.
In one example, (UCI part 1, UCI part2) includes (part 1 of beam/CSI, part 2 of beam/CSI), respectively.

In one example, UCI part 1 can be more protected (lower MCS) than UCI part 2. For two-part UCI, and two UL slots on PUSCH
In one example, one trigger (via DCI) is used for both UL slots. In one example, 2 offset values are indicated, one for each UL slot. In one example, one offset value is indicated, and the other offset value is determined based on the indicated offset value, e.g., the other offset o₂=o₁+ν where o₁ is the indicated offset value, and ν is a fixed value, or configured via RRC or MAC CE or DCI.

For three-part UCI,
In one example, (UCI part 1, UCI part2, UCI part 3) includes (beam report, CSI part 1, CSI part2), respectively.
In one example, (UCI part 1, UCI part2, UCI part 3) includes (port or PG or/and port selection information, CSI part 1, CSI part2), respectively.
In one example, (UCI part 1, UCI part2, UCI part 3) includes (port or PG or/and port selection information, part 1 of beam/CSI, part 2 of beam/CSI), respectively.

In one example, the port or PG selection reporting includes a 2D (or a pair) information, e.g. (indices of selected ports or PGs, hypothesis index) or (indices of selected ports or PGs, layer index).
In one example, this reporting is WB, i.e., the 2D information is the same/common for all SBs.
In one example, this reporting is per SB, i.e., for each SB, a 2D information is reported. In one example, the SB size can be wider (larger than) that for CQI/PMI reporting.

In one example, the port or PG selection reporting is according to at least one of the following examples.
In one example, the port or PG or/and port selection is performed only for CSI reporting.
In one example, the PG or/and port selection can be performed for beam reporting. In one example, port is equivalent to a beam. Each port or PG can be configured with multiple measurement RSs for beam reporting.
In one example, the port or PG or/and port selection can be performed for both beam reporting and CSI reporting. The selection can be joint/together or separate/decoupled.
In one example, the port or PG or/and port selection is reported jointly together with CSI/beam report.

In one embodiment, a port or PG can comprise/include or be associated with one or multiple entities of the same type. Additionally, the selection/indication/reporting of at least one entity out of the multiple entities can be performed as described above for the case when entity type corresponds to antenna/port.
In one example, the entity type corresponds to antenna port.
In one example, the entity type corresponds to beam, or TCI state, or QCL-Info, or QCL-TypeD or source RS (or other QCL-Types).
In one example, the entity type corresponds to a sub-configuration (subset) of CSI-RS port configuration (which can be configured for NES or RIS).
In one example, the entity type corresponds to a hypothesis (e.g., CJT, NCJT, sTRP).

In one embodiment, for next generation MIMO systems (e.g., 6G), an AG based framework is used to support several advanced features such as the following.

In one example, a distributed NW topology is a key enabler considering new future market needs of the cellular industry (e.g., >52.6 GHz, upper mid-band, THz bands, mobility, duplexing, NES). It can support both legacy (cell-centric) NW as a specific configuration and new (cell-free/boundary-less or user-centric/beam-based) NW. In 3GPP, schemes for such NW topologies have been discussed/supported, e.g., dynamic point selection (DPS), coordinated scheduling/BF (CS/CB), NCJT, and CJT. These schemes are now feasible/implementable owing to disaggregated 5G RAN, i.e., distributing RAN functions into centralized unit (CU), distributed unit (DU), and radio unit (RU), and fast fronthaul solutions to connect the units, such as enhanced common public radio interface (eCPRI). Two new features have been adopted in the current release: dynamic TRP selection and enhanced Type-II CSI assuming CJT. These are crucial to improve spectral efficiency, especially in frequency bands with limited bandwidth. In high frequency bands (e.g., mmWave) also, due to large propagation loss and a (analog) beam-based air interface, the channel is likely to be sparse, implying that the distributed NW topology with frequent (analog) beam update is essential. It is also expected that new antenna architectures (e.g., non-uniform) will be relevant in 6G. As an example, a radio stripe system has been introduced for TDD systems wherein the antenna elements and associated processing units are integrated inside multiple connected radio stripes, and thereby, a flexible deployment to attach irregular surfaces becomes feasible. Also, another practical architecture for FDD was introduced, distributed massive MIMO using modular antenna structures, where several basic antenna modules are predefined, and it is considered that any combination of them can flexibly be deployed and connected to form a single MIMO system. MIMO supporting such flexible antenna structures will require more advanced, modular, and scalable framework than that for 5G in order to ensure efficient communication between the NW and the user.

In one example, the most resource-efficient beam reporting is aperiodic (AP), in conjunction with aperiodic CSI-RS. Although a NW-triggered AP beam reporting is preferred, in some scenarios where the NW lacks knowledge on the DL channel condition or the user knows the DL channel condition better, it is clearly beneficial if AP beam reporting is user-initiated or event-driven. For instance, when the user is configured only with AP beam reporting and the channel condition is worsened to the point of beam failure, the loss of link due to beam failure can be avoided if the user can transmit the AP beam report without having to wait for a trigger from the NW. Likewise, the user can trigger a new beam switch without having to wait for a beam switch indication from the NW. This would also reduce overhead and latency significantly, especially in high mobility scenarios.

In one example, the ICBM-based mobility can be simplified to an AG-based mobility wherein AGs replace cells, and mobility essentially is handled by AG selection/update, i.e., moving from one set of AGs to another set. NES and advanced duplexing can also be supported based on dynamic AG assignment.

In one embodiment, an AG can be the basic NW entity (e.g. for 6G) since it can be an abstraction for antenna panel (N_{g}=1), TRP (N_{g}≥1), CSI-RS antenna ports of a NZP CSI-RS resource (N_{g}=1), a subset of CSI-RS antenna ports of a NZP CSI-RS resource (N_{g}≥1), CSI-RS antenna ports of multiple NZP CSI-RS resources comprising a CSI-RS resource set.

A SD precoding/BF can be used across antenna ports in order to achieve MIMO gains. Depending on the carrier frequency and the feasibility of RF/HW-related components, the SD precoding/BF can be fully-digital or hybrid analog-digital. In a fully-digital BF, there can be one-to-one mapping between an antenna port and an antenna element, or a ‘static/fixed’ virtualization of multiple antenna elements to one antenna port can be used. Since antenna port can be digitally controlled, a spatial multiplexing across all antenna ports is possible and the maximum possible MIMO gain can be achieved. For intra-AG precoding, N_{g}=1 and antenna ports belong to one AG, and for inter-AG precoding, N_{g}>1 and antenna ports are aggregated across multiple AGs.

In a hybrid analog-digital BF, analog BF corresponds to a ‘dynamic/varying’ virtualization of multiple antenna elements to obtain one antenna port (or antenna panel), details as described above The spatial multiplexing gain is controlled by the number of antenna ports and the analog beam (phase shifters) at each antenna port. When an AG corresponds to Nₚₐₙₑₗ>1 antenna panels, P_{g}=Nₚₐₙₑₗs_{g}.

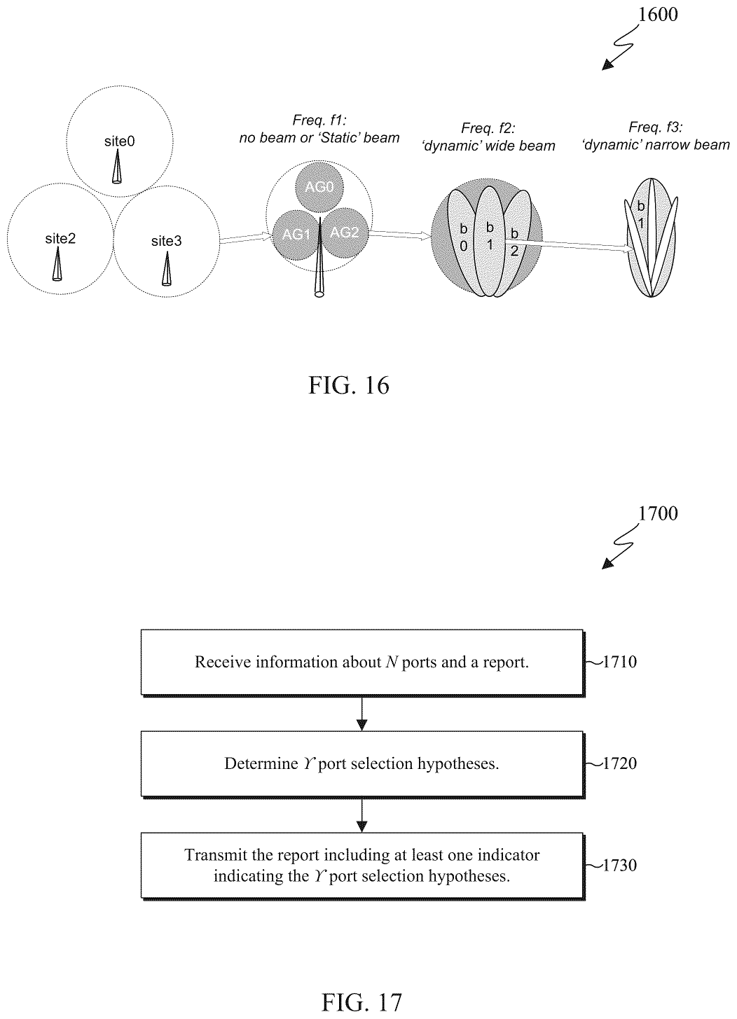

FIG. 16 illustrates an example of an analog beam-based NW topology 1600 according to embodiments of the present disclosure. The embodiment of the analog beam-based NW topology 1600 illustrated in FIG. 16 is for illustration only. FIG. 16 does not limit the scope of this disclosure to any particular implementation of analog beam-based NW topologies.

A cellular region can be served by partitioning (or covering) the region into (with) multiple sites and deploying multiple AGs at each site. An example is illustrated in FIG. 16 wherein there are three AGs per site. For a frequency f1 (e.g., in FR1), each AG is controlled by a fully-digital processing chain, implying there is no analog beam or a fixed beam, and all AGs at one site together can serve users belonging to the respective site. At a higher frequency f2 (e.g., in FR2), each AG is associated with a hybrid analog-digital structure, implying each antenna port of the AG needs to be assigned/updated with one of the three wide beams. At an even higher frequency, since analog beams get narrower (reduced beam-width), number of analog beams increases, hence antenna ports of an AG need to be assigned/updated with one of the nine narrow beams. In general, an AG can be assigned/updated with A_{g} analog beams. When A_{g}=1, there is one analog beam per AG. When A_{g}=s_{g}, three is one analog beam per polarization per AG. When A_{g}=Nₚₐₙₑₗ, there is one analog beam per antenna panel/port per AG. When A_{g}=Nₚₐₙₑₗs_{g}, there is one analog beam per polarization per antenna panel/port per AG.

In a mobility scenario, multiple AGs can serve a moving user. An illustration is shown in FIG. 11B. While the user moves from a location A to another location B, the set of AGs is updated from {AG2, AG3, AG4} to {AG1, AG2}.

In one embodiment, parameters relevant for AGs are as tabulated in TABLE 1. Depending on carrier frequency, BF, and NW topology, the user can be configured with N_{y} AGs and values of relevant parameters. A few examples of the configuration are shown in TABLE 2. For Config 1,2,4, an AG can include two antenna ports/panels (s_{g}=2), and they can have the same analog beam.

TABLE 1

| | Values | |
|---|---|---|
| Parameters | Fully-digital | Hybrid BF |
| Number of AGs, N_{g} | {1,2,3,4} | Number of panels, Nₚₐₙₑₗ ∈ |
| | | {1,2,4} |
| Number of ports per AG, P_{g} | {1,2,4, ... ,256} | 1 |
| Number of beams per port, | 1 | 1 ≤ n_{b} ≤ 256 |
| N_{b} | | |
| FD granularity | T-F patterns, repeats across | WB |
| TD granularity | RBs | Multiple symbols (one per |
| | | beam) |
| Density ρ (REs per RB) | {0.5,1} | {1,3} |
| Measurement | One-shot: AP | Beam-sweeping (symbol-level) |
| | Multi-shot: P/SP | |

TABLE 2

| Config | N_{g} | P_{g} | N_{b} | |
|---|---|---|---|---|
| 1 | ≥1 | 1 | 1 | |
| 2 | ≥1 | >1 | 1 | |
| 3 | ≥1 | n | n | P_{g} = N_{g} |
| 4 | m | 1 | m | N_{g} = N_{b} |
| 5 | m | n | mn | N_{g}P_{g} = N_{b} |

In one embodiment, a user is configured with a dynamic MIMO framework based on two components: 1) AG adaptation/selection and common long-term stats and assumptions, and 2) fast and accurate CSI acquisition. The two components can be together/joint or decoupled. When latter, 2) can be based on (conditional on) 1).

Let γ≥1 be a number of AG selection hypotheses. For each l ∈{1, . . . , γ}, an AG selection hypothesis selects nₗ AGs, where 1≤nₗ≤N_{AG}. The AG selection can either be user-reported (performed by the user, and reported to the NW), or NW-controlled (performed by the NW, and indicated to the user), and can either be a standalone/separate or a non-standalone procedure. When non-standalone, the AG selection can be included or/and multiplexed either with a DL indication such as beam or TCI state indication, or with a report (e.g., CSI or beam report). When user-reported, the AG selection report includes an information about the selected {nₗ} AGs, and can also include a metric (e.g., RSRP, power level, SINR). The AG selection is signaled dynamically, e.g., via a MACE CE or a DCI or a DCI with MAC CE activation (similar to beam/TCI state indication) or via UCI (similar to aperiodic beam/CSI report). Note that the AG selection can support both NW-controlled features such as beam (TCI state) indication, TRP indication (CJT), port indication (non-PMI feedback), sub-configurations (NES), and SBFD (duplexing); and User-reported features such as dynamic TRP selection (CJT), dynamic port selection (PS T₂ codebook).

Embodiments of the present disclosure provide for QCL assumptions between AGs. A QCL relationship corresponds to LT channel properties that the user can assume to be the same/common across antenna ports associated with AGs. Relevant LT channel properties include:
Angular profile: spatial filter parameter (analog beam)
Delay profile: average delay, delay spread
Doppler profile: Doppler shift, Doppler spread

A QCL relation can include one or multiple of LT channel properties, and a few types of QCL relations are as follows:
{Doppler shift, Doppler spread, average delay, delay spread}
{Doppler shift, Doppler spread}
{Doppler shift, average delay}
{Spatial filter parameter}

Embodiments of the present disclosure provide for coherency assumptions between AGs. The coherency can be (1) full-coherence (FC), a layer (stream) can be transmitted using all antenna ports, (2) partial-coherence (PC), i.e., a layer (stream) can be transmitted using at least two but not all antenna ports, or (3) non-coherence (NC), i.e., a layer (stream) can be transmitted using one antenna port.

For antenna ports within an AG, LT channel properties (QCL and coherency) remain the same, and for antenna ports across AGs, LT channel properties (QCL and coherency) can be different.

The CSI for the selected AGs can be configured based on the following:
Number of analog beam: when N_{b}=1, antenna ports within an AG are FC and antenna ports across multiple AGs can be FC/PC/NC, and when N_{b}>1, antenna ports within an AG can be FC/PC/NC and antenna ports across multiple AGs are NC.
Report quantity 1 (beam-related CSI):
   AG-common hypotheses: γ hypotheses are common for all AGs.
   AG-specific hypotheses: γ=Σ_{g=1}^{N}^{_{g}} γ_{g} and γ_{g} is number of hypotheses for AG g.
Report quantity 2 (non-beam-related CSI):
   Multiple CSI hypotheses: CSI for one of or a subset of or all of γ hypotheses
   Layer-common hypothesis: γ=1
   Layer-specific hypothesis: γ=ν(number of layers)
Report quantity 3 (both beam-related and non-beam-related CSI):
   Combinations of above

In one embodiment, at a low speed, Type II CSI shows large performance gain over Type I CSI. As speed increases, the performance of Type II CSI starts to deteriorate at a faster rate than that of Type I. After a certain speed, the performance of Type II CSI becomes worse than Type I CSI. NW can alleviate this loss in performance at higher speed (e.g., based on UL channel measurement), but it consumes UL resources and may still not work for far (cell-edge) users. A superior scheme can be based on dynamic selection of a value for L (e.g., from {1, 2, 3, 4}) and corresponding L SD vectors. When L=1 is selected, Type I CSI is reported, and when L>1, enhanced Type II CSI is reported.

In one embodiment, in a beam-based air interface, multiple users' case be served based on MU-MIMO or SDMA. For MU-MIMO, NW needs to perform joint scheduling of (user, beam) combinations. For SDMA, antenna ports (beams) need to be partitioned among scheduled users. When two users have the same optimal beams for the different RF chains, the MU interference can be very severe. To reduce MU interference, we can assign only a subset of antenna ports for MU-MIMO, and the rest of the antenna ports can be assigned to a single user or multiple SDMA users. To achieve a tradeoff between interference and MU gains, we propose a hybrid scheme which combines SDMA and MU-MIMO. A subset of antenna ports with close beams is selected for MU-MIMO and the rest of the antenna ports is used for SDMA, where the ‘close’ beams are based on comparing the correlation coefficient of two analog BF weights with a threshold. After SDMA and MU-MIMO antenna ports are identified, scheduling is performed independently within the two sets of antenna ports. Since two sets of antenna ports are for different schemes, precoder needs to be calculated independently for the two. Finally, the precoders are normalized based on the number of the antenna ports for SDMA and MU-MIMO. The NW can request a beam report from the scheduled users for the scheduled beams to assist scheduling and improve performance.

FIG. 17 illustrates an example method 1700 performed by a UE in a wireless communication system according to embodiments of the present disclosure. The method 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving information about N ports and a report (1710). For example, in 1710, each of the N ports is associated with a spatial beam. For example, the spatial beam may be indicated via a source RS and a QCL-type that are included in a QCL-info or a TCI state.

The UE then determines γ port selection hypotheses (1720). For example, in 1720, a port selection hypothesis with index l selects a group of nₗ ports from the N ports, where γ≥1, l ∈{1, . . . , γ}, and 1≤nₗ≤N. In various embodiments, the information further indicates a set of candidate port selection hypotheses, and the UE determines the γ port selection hypotheses based on the set of candidate port selection hypotheses. In various embodiments, the each hypothesis corresponds to a PG and the report includes a PGI.

The UE then transmits the report including at least one indicator indicating the γ′ port selection hypotheses (1730). For example, in 1730, the at least one indicator indicating the Y port selection hypotheses corresponds to a bit sequence comprising Nγ bits, where N bits are associated with each of the γ port selection hypotheses. In various embodiments, γ is a number of layers and each of the γ port selection hypotheses is associated with a layer. For example, the report may further include CSI corresponding to the γ layers.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about N ports and a report; and
a processor operably coupled to the transceiver, the processor, based on the information, configured to determine γ port selection hypotheses, where a port selection hypothesis with index l selects a group of nₗ ports from the N ports,
wherein the transceiver is further configured to transmit the report including at least one indicator indicating the γ port selection hypotheses,
where γ≥1, l ∈{1, . . . , γ}, and 1≤nₗ≤N.

2. The UE of claim 1, wherein the at least one indicator indicating the γ port selection hypotheses corresponds to a bit sequence comprising Nγ bits, where N bits are associated with each of the γ port selection hypotheses.

3. The UE of claim 1, wherein:
the information further indicates a set of candidate port selection hypotheses, and
the processor is further configured to determine the γ port selection hypotheses based on the set of candidate port selection hypotheses.

4. The UE of claim 1, wherein γ is a number of layers and each of the γ port selection hypotheses is associated with a layer.

5. The UE of claim 4, wherein the report further includes channel state information (CSI) corresponding to the γ layers.

6. The UE of claim 1, wherein each of the N ports is associated with a spatial beam.

7. The UE of claim 6, wherein the spatial beam is indicated via a source reference signal (RS) and a quasi-co-location (QCL)-type that are included in a QCL-info or a transmission configuration indicator (TCI) state.

8. The UE of claim 1, wherein each port selection hypothesis corresponds to a port group (PG) and the report includes a PG indicator (PGI).

9. A base station (BS) comprising:
a processor; and
a transceiver operably coupled to the processor, the transceiver configured to:
transmit information about N ports and a report; and
receive the report including at least one indicator indicating γ port selection hypotheses, where a port selection hypothesis with index l selects a group of nₗ ports from the N ports and where γ≥1, l ∈{1, . . . , γ}, and 1≤nₗ−N.

10. The BS of claim 9, wherein the at least one indicator indicating the γ port selection hypotheses corresponds to a bit sequence comprising Nγ bits, where N bits are associated with each of the γ port selection hypotheses.

11. The BS of claim 9, wherein:
the information further indicates a set of candidate port selection hypotheses, and
the γ port selection hypotheses are based on the set of candidate port selection hypotheses.

12. The BS of claim 9, wherein γ is a number of layers and each of the γ port selection hypotheses is associated with a layer.

13. The BS of claim 12, wherein the report further includes channel state information (CSI) corresponding to the γ layers.

14. The BS of claim 9, wherein each of the N ports is associated with a spatial beam.

15. The BS of claim 14, wherein the spatial beam is indicated via a source reference signal (RS) and a quasi-co-location (QCL)-type that are included in a QCL-info or a transmission configuration indicator (TCI) state.

16. The BS of claim 9, wherein each port selection hypothesis corresponds to a port group (PG) and the report includes a PG indicator (PGI).

17. A method performed by a user equipment (UE), the method comprising:
receiving information about N ports and a report;
based on the information, determining γ port selection hypotheses, where a port selection hypothesis with index l selects a group of nₗ ports from the N ports; and
transmitting the report including at least one indicator indicating the γ port selection hypotheses,
where γ≥1, l ∈{1, . . . , γ}, and 1≤nₗ≤N.

18. The method of claim 17, wherein the at least one indicator indicating the γ port selection hypotheses corresponds to a bit sequence comprising Nγ bits, where N bits are associated with each of the γ port selection hypotheses.

19. The method of claim 17, wherein:
the information further indicates a set of candidate port selection hypotheses, and
determining the γ port selection hypotheses comprises determining the γ port selection hypotheses based on the set of candidate port selection hypotheses.

20. The method of claim 17, wherein γ is a number of layers and each of the γ port selection hypotheses is associated with a layer.
